(19) United States
(12) Patent Application Publication
(10) Pub. No.: US 2005/0050030 A1
(43) Pub. Date: Mar. 3, 2005

(54) Set definition language for relational data

(75) Inventors: Hakon Gudbjartsson, Reykjavik (IS); Thorvaldur S. Arnarson, Reykjavik (IS); Pavol Rovensky, Kopavogur (IS); Vilmundur Palmason, Mosfellsbacr (IS)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: deCODE genetics ehf., Reykjavik (IS)

(21) Appl. No.: 10/895,620

(22) Filed: Jul. 20, 2004

Related U.S. Application Data
(63) Continuation-in-part of application No. 10/603,112, filed on Jun. 24, 2003.
Application No. 10/603,112 is a continuation-in-part of application No. 10/356,365, filed on Jan. 30, 2003.

(51) Int. Cl. G06F 17/00

(52) U.S. Cl. 707/3

(57) ABSTRACT

The present invention relates to the usage pattern, commonly found in many software applications, of defining sets of objects based on object attributes. A specifically designed set definition language for defining sets, called SDL, is described and a software system that implements this language efficiently on top of a standard relational database management system (RDBMS) is presented. The unique features of the SDL language are the implicit constraints that are enforced on the relational data that belong to the objects. Unique to the SDL system is also the logical metadata of dimensions that enables the SDL system to enforce these constraints across relations. The SDL system utilizes several optimization techniques to enable efficient implementation on top of RDBMS. It is also shown how the SDL language and the SQL language can be merged with bidirectional inlining using syntactic gates. Query composition tools are also described that facilitate the creation of SDL expressions.

### RELATED APPLICATIONS

This application is a continuation-in-part of U.S. application Ser. No. 10/603,112 filed Jun. 24, 2003 which is a continuation-in-part of U.S. application Ser. No. 10/356,365, filed Jan. 30, 2003. The entire teachings of the foregoing applications are incorporated herein by reference.

### BACKGROUND OF THE INVENTION

In the past years, there has been an exponential growth in electronic data and information gathering in many fields. This growth is partly due to advances in computer technology, greatly enhanced storage capacity and improvements in the interconnection of computers. In particular, in the life-sciences this data explosion is also due to automation and highly advanced measurement technology, e.g. the sequencing technology used in the human genome project. With ever increasing volume of data, the need for searching and analyzing data can only continue to grow.

The work presented herein by applicants on the Set Definition Language (SDL) and the corresponding SDL system originates from the work of assignee deCODE Genetics Inc. on a centralized Icelandic healthcare database and the development of a knowledge discovery system for clinical, genealogical and genetic data. Although the development is motivated by life-science applications, the language is quite generic and can easily be utilized in other fields as well. Most commercial decision support systems that are currently available have been designed with the aim of providing business intelligence for financial related data.

Thus, although the term on-line analytical processing (OLAP), which was originally coined by Codd ((Codd, E. F., “Providing OLAP (on-line analytical processing) to user-analysts: An IT mandate,” Tech. rep., E. F. Codd and Associates, 1993)) was meant to represent quite general analysis capabilities, in practice OLAP has become synonymous with multi-dimensional hypercube analysis. ((See Chaudhuri, S. and U. Dayal, “An overview of data warehousing and OLAP technology,” SIGMOD Rec. 26(1):65-74 (1997) and Colossi, N. et al., “Relational extensions for OLAP” IBM Systems Journal 41(4):714-731 (2002)). There are various reasons why OLAP has come to have this restricted meaning, but without a doubt, performance requirements in the business field play an important role. Therefore, the analytical operations are often limited to aggregation operations that are distributive in nature and have efficient implementation. ((See Harinarayan, V. et al., “Implementing data cubes efficiently,” in Proc. of ACM SIGMOD Conference on Management of Data (1996), and Zhao, Y. et al., “An array-based algorithm for simultaneous multidimensional aggregates,” in Readings in database systems, 3rd ed., M. Stonebraker and J. M. Hellerstein, Eds., Morgan Kaufinann Publishers, Inc., 568-579, (1998)).

Although the analytical capabilities of conventional OLAP decision support systems have been found to be useful in the life-sciences they are nevertheless inadequate. ((See Nigrin, D. J. and I. S. Kohane, “Data mining by clinicians,” in Proc AMIA Symp. 957-961 (1998)). There are several reasons for this such as the “high dimensionality” and the variable number of attributes associated with life-science data. ((See Nadkarni, P. M. and C. Brandt, “Data extraction and Ad Hoc query of an entity attribute-value database,” Journal of the American Medical Informatics Association 5 (6):511-517 (1998) and Cheung, K. H. et al., “A metadata approach to query interoperation between molecular biology databases,” Bioinformatics 14(6): 486-497, 1998)). Also, it is problematic to express non-disjoint conditions and support for multiple taxonomies that are not simple balanced hierarchies (Lieberman, M. I., “The use of SNOMED to enhance querying of a clinical data warehouse,” M.S. thesis, School of Medicine, Oregon Health and Science University (2003)), e.g. direct acyclic graphs (DAG), is typically not provided. In addition, there is a lack of temporal expressiveness and capabilities to deal with event based data, such as for clinical epidemiological analysis. ((See Das, A. K. and M. A. Musen, “A comparison of the temporal expressiveness of three database query methods,” In Proceedings of the Nineteenth Annual Symposium on Computer Applications in Medical Care, pp. 331-337 (1995); Nigrin, D. J. and I. S. Kohane, “Temporal expressiveness in querying a time-stamp-based clinical database,” Journal of the American Medical Informatics Association 7(2):152-163 (2000); and Connor, M. J. et al., “A specification for a temporal query system,” Tech. Rep. SMI-1999-0816, Stanford Medical Informatics (1999)). It is clear that in order to complement the standard decision support systems with these capabilities with current computer technology, a compromise needs to be made between analysis speed and analytical power. In applicants' view, it is very important to provide scientists with the capabilities to easily express sophisticated queries without the intervention of a programmer or a database expert, and although rapid response times are of importance, they can nevertheless be relaxed as compared to standard commercial OLAP systems.

So far, no de facto standard has emerged for analyzing life-science data that is equivalent to commercial OLAP systems, and the field is still quite dispersed. In the past, several approaches have been taken in order to provide clinicians and researchers the capacity to express direct queries to database systems. These include specific query languages such as MQL (Safran, C. et al., “ClinQuery: A system for online searching of data in a teaching hospital,” Ann Intern Med. 111(9):751-756 (1989) and HQL (MIQUEST. 2002 “Miquest and health query language” http://www.clinicalinfo.co.uk/miquest.htm) or semi visual frameworks that simplify the query building process such as QBE (Zloof, M. M., “Query-by-example: a database language,” IBM Systems Journal 16(4):324-343 (1977)). One of the main obstacles for users is the requirement to have intimate knowledge of the underlying database schema. In the HQL system for instance, this is alleviated by standardizing or fixing a relatively simple schema such that understanding the schema becomes part of learning the language. This of course has the drawback of limiting the scope of the language and provisions for extensions. Data abstraction has also been used as a mechanism to simplify the user task of creating queries. The concept of the “universal relation” ((Biskup, J. and Brüggemann, H. H. 1983, “Universal relation views: A pragmatic approach,” In 9th International Conference on Very Large Data Bases, Oct. 31-Nov. 2, 1983, Florence, Italy, Proceedings, M. Schkolnick and C. Thanos, Eds. Morgan Kaufmann, pp. 172-185; Maier, D. et al., “On the foundations of the universal relation model,” ACM Trans. Database Syst. 9(2):283-308 (1984); and Maier, D. et al, “Pique: A relational query language without relations,” Inf Syst. 12(3):317-335 (1987)) was aimed at sparing the user from navigating relations and directly specifying table joins. Visual query frameworks based on similar ideas have been commercialized (Cambot et al., U.S. Pat. No. 5,555,403, issued Sep. 10, 1996), however, in the universal relational model certain queries cannot be specified without explicit joins and aliases and this model is not well suited for handling of longitudinal event based data.

Many graphical query systems have also been introduced specifically for providing ad-hoc queries ((Siau, K. L. et al., “Visual knowledge query language as a front-end to relational systems,” in Proc. of 15th Annual International Computer Software and Applications Conference IEEE Computer Society Press, Tokyo, 373-378 (1991); Etzold, T. and Argos, P., “SRS—an indexing and retrieval tool for flat file data libraries,” Computer Applications in the Biosciences 9(1):49-57 (1993); Banhart, F. and Klaeren, H., “A graphical query generator for clinical research databases”, In Meth Inform Med. Vol. 34, 328-339 (1995); Stoffel, K. et al., “A graphical tool for ad hoc query generation,” In Proc. AMIA Symposium 503-507 (1998); Nadkarni et al. (1998); Murphy, S. N. et al., “Optimizing healthcare research data warehouse design through past COSTAR query analysis,” In Proceedings of AMIA Symposium, pp. 892-896 (1999); Murphy, S. N. et al., “Visual query tool for finding patient cohorts from a clinical data warehouse of the Partners HealthCare System, In Proceedings of AMIA Symposium (2000); Goble, C. A. et al., “Transparent access to multiple bioinformatics information sources,” IBM Systems Journal 40(2):532-551 (2001); and Eckman, B. A. et al., “Extending traditional query-based integration approaches for functional characterization of post-genomic data” Bioinformatics 17(7):587-601 (2001)). Most often these systems do not have a query language that is specifically intended for the user, although in some systems the user can get access to the underlying query language and the auto-generated queries. Although graphical query systems may have the lowest learning threshold for beginners, their visual layouts are not standardized and therefore, often only a modest query complexity requires knowledge about non-obvious system behavior to interpret the query semantics. Furthermore, systems that rely on specific query dialogs do not support easily the combinatorial flexibility and power of language based systems nor do they support easy scripting capabilities.

### SUMMARY OF THE INVENTION

The design philosophy behind the SDL of the present invention and related applications was to build a decision support system around a simple language that is targeted at the general research user. The system uses metadata and schema abstraction to hide much of the data complexity, and the language syntax was made as concise and intuitive as possible while trying to preserve expressive power. For objects which data is fully contained in a single data record this is easily achieved, however, for data objects that are composed of multiple attributes, some of which are collections, this is less trivial. Applicants believe that many of these goals have been achieved, partly by implying exist clause on collection predicates, partly by enforcing implicit relational joins, and partly by what applicants refer to as automatic record locking. The language is also structured in such a manner that GUI tools are easily built to facilitate the query composition. Thus, the simplest SDL queries can be formed by a single drag-and-drop, but of course, advanced conditional expressions can never be trivial, if the meaning of the expression has to be contained in the language statement.

Apart from the more general requirements mentioned above, the SDL system was indirectly motivated by special privacy requirements originating in the Icelandic centralized healthcare database project, i.e. to enable the users to define population subsets without a direct access to the underlying data. This privacy protection is however compatible with the requirement to provide abstraction of the underlying data structures in order to simplify the query building process for the user. Hence, unlike in many report based decision support systems, a set-definition in the SDL system is a stand-alone expression that defines a set independent from the views. These views can be graphical or textual and may or may not represent the attributes that form the expression of a given set.

In the following sections, applicants present the SDL language through examples that relate to many of the life-science oriented issues mentioned above. First, the SDL metadata is described and the data abstraction of concrete data relations that is achieved through what applicants refer to as virtual relations. Next applicants present a method to incorporate virtual relations into a variant or a superset of SQL (SSDL) and continue to use this SQL dialect throughout the following to describe the semantics of the SDL language and to present how the SDL language is implemented on a RDBMS. Finally, the limitations of plain SDL are discussed, it is shown how SDL and SSDL can be merged with a so-called bidirectional inlining and how it provides a powerful framework to augment the SDL language with special SDL template functions. Similarly, it is presented how the data abstraction of extended virtual relations can be used to simplify report generation in SSDL.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of the computer architecture of one embodiment of the invention SDL system.

FIGS. 2A and 2B are schematic illustrations of automatic record locking.

FIGS. 3A and 3B are schematic illustrations of extended virtual relations.

FIG. 4 illustrates an XML/Object report in the present invention.

FIG. 5 is a schematic illustration of an extended virtual relation table report in the present invention.

FIG. 6 is a blocked diagram of data abstraction architecture in a preferred embodiment.

FIG. 7 is a schematic illustration of feature provider architecture in a preferred embodiment of the present invention.

### DETAILED DESCRIPTION OF THE INVENTION

As mentioned earlier, the SDL system and its language was developed with the particular aim in mind to facilitate ad-hoc queries for scientists working with life science data. Hence, the usefulness of the language depends not only on its syntax but also on how well the GUI components support the language and the process of composing queries. In this text, applicants primarily focus on the invention SDL language and its semantics but mention GUI related design issues where it facilitates understanding of the language design.

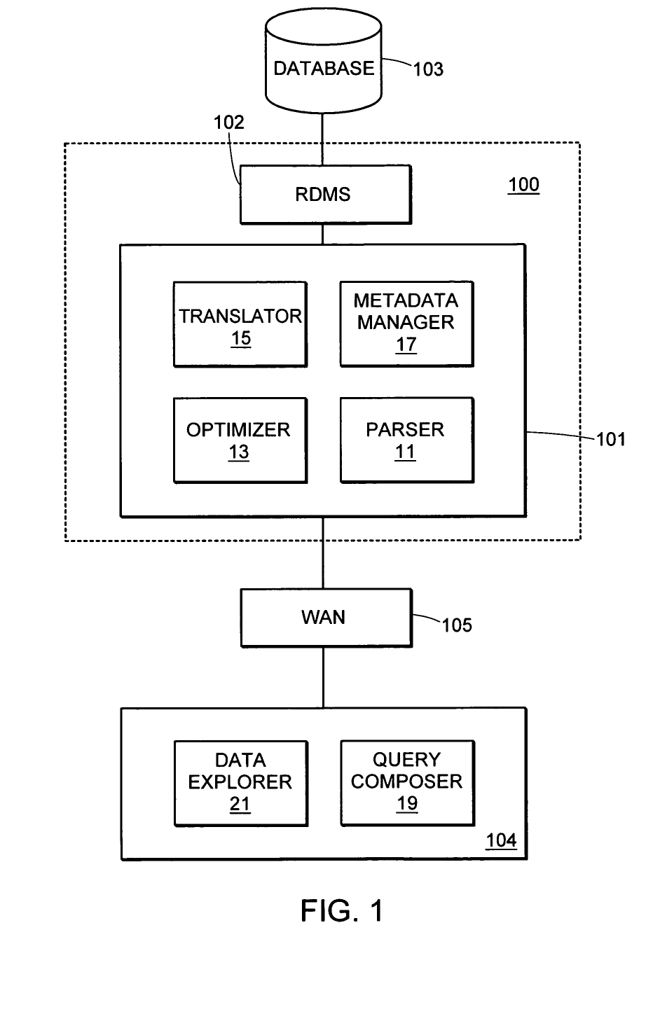

An important aspect in the overall system design was to use metadata to make data “application independent” and ensure that no logic is embedded in applications that is necessary for interpreting the meaning of data. This metadata is also used to provide data dependent logic to specialized GUI components and widgets that can be used to facilitate application development. An example of such modules are SDL syntax aware editor, data browsing and data entry widgets, etc. A high level system architecture diagram is presented in FIG. 1 but a more detailed description of SDL application development tools are provided elsewhere.

Illustrated in FIG. 1 are the major functional modules of the client side 104 and server side 100 of the invention SDL system. The SDL server system 100 consists of several components 101. In the preferred embodiment the components 101 include a parser 11, optimizer 13, translator 15 (to generate the necessary code) and a meta-data module 17. The SDL server 100 is also comprised of an RDBMS (Relational Database Management System) 102 and hard disks 103 for the storage of the data. Module 17 manages domains, dimensions and their mapping to the RDBMS 102 data structures of database 103.

It is a matter of configuration whether RDBMS 102 and components 101 reside in the same computer or whether they are kept on different computers. The server 100 is connected to an SDL client 104 through a wide area or similar network 105. The client 104 can either be an application specifically designed for SDL or a SDL query component bundled into a host application. Generally client 104 is formed of a query composer 19 and a metadata navigation component 21.

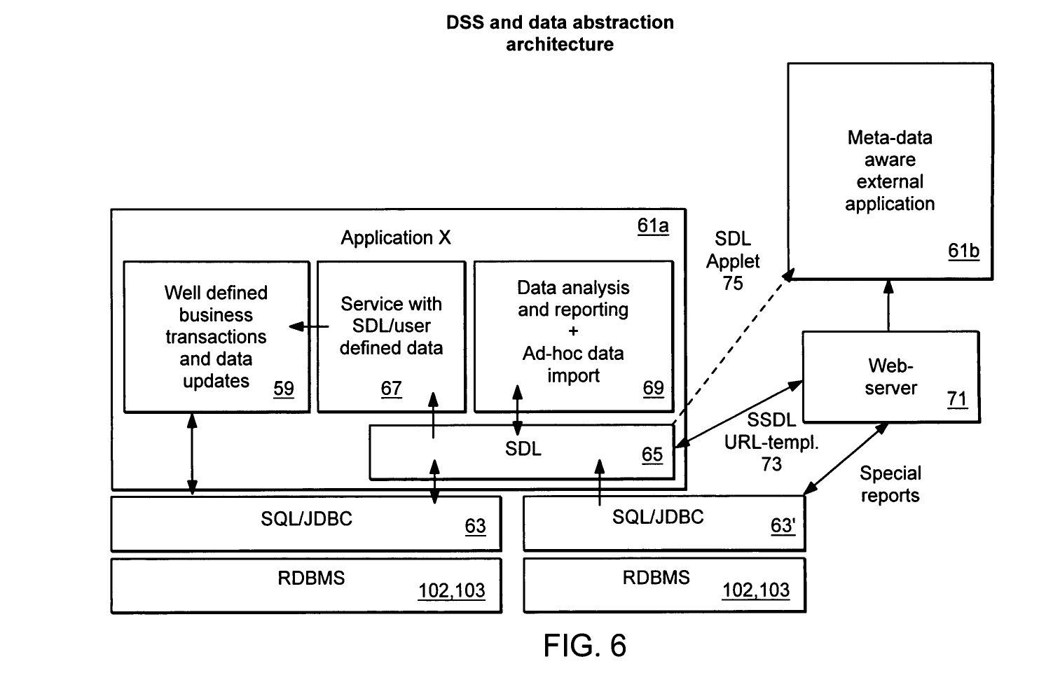

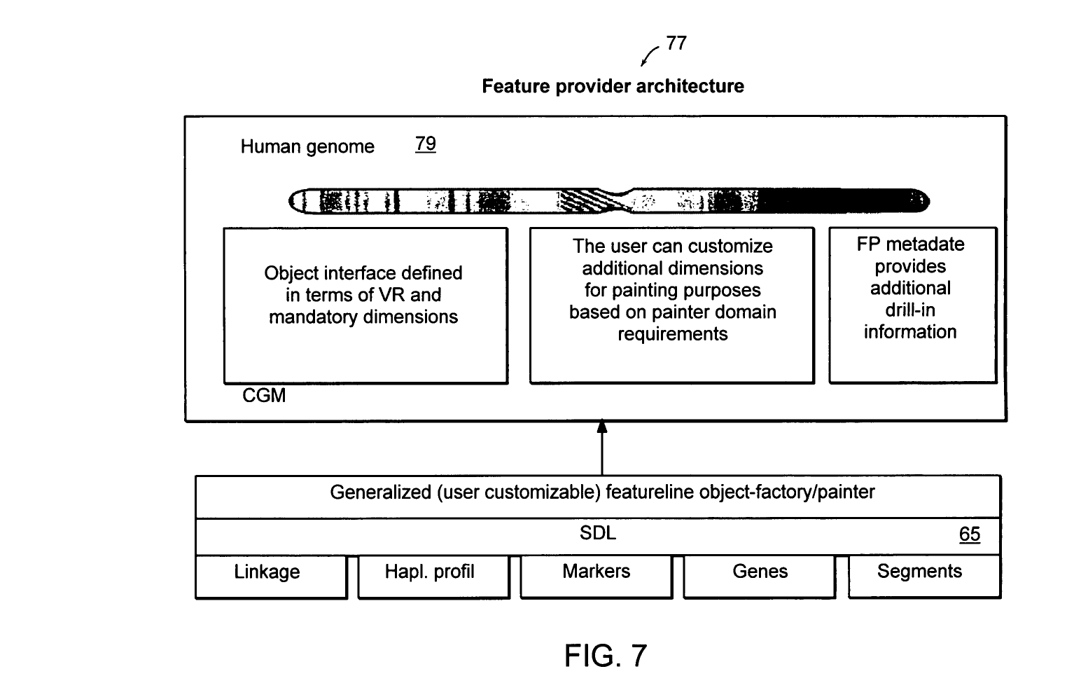

In a preferred embodiment, the data abstraction and feature provider architectures are as illustrated in FIGS. 6 and 7. With respect to FIG. 6, an application 61a has a typical relational language (e.g., SQL, JDBC) interface 63 with the database system 102, 103. Various defined transactions and data updates are made by the application 61, interface 63 and RDBMS 102 cooperating with each other (as illustrated at 59).

The invention SDL 65 is embedded or otherwise coupled to the application 61. Application objects are made available as SDL objects. SDL metadata 17 is moved into the application 61. As a consequence, services with SDL user defined data can be made at 67. Further data analysis, reporting and ad-hoc data import are enabled at 69.

The foregoing may be accomplished by local and/or remote processing. For the latter, there is an interface 63′ similar to local interface 63 that communicates between invention SDL module 65 and RDBMS 102, 103. Remote communications may be made through a Web based server 71, for example for special reports requests, etc. An SSDL URL-template 73 provides location mapping between SDL application 61 and Web server 71. SDL applets 75 carry and communicate SDL metadata 17 between applications 61.

Thus a client user 104 (FIG. 1) of application 61 locally composes a query 19 (in SDL) and submits the query across a WAN or global network 105 to Web based or other server 71, 100. The server 100 RDBMS 102, 103 interprets the SDL query into SQL and abstracts the pertinent data. The server 71, 100 communicates the abstracted data to the requesting application 61/client 104. In particular, the returned data is used in data analysis and reporting at 69 (FIG. 6).

With reference to FIG. 7, in the preferred embodiment, once user-desired data 79 is retrieved, i.e., extracted and returned as described in FIG. 6, a feature provider 77 enables data exploration 21 (FIG. 1) and display to the user.

Preferably feature provider 77 in a biotechnology application 61 provides display of linkage data (of the retrieved data with respect to related sequence data) haplotype profiles, markers, corresponding genes and other segments. The SDL layer 65 provides the interface for user-customizable feature line specification and object painting/highlighting. To that end, data objects 79 are designated in terms of virtual relations and mandatory dimensions. The user can customize additional dimensions for painting purposes. Feature provider 77 metadata provides additional drill down information for displaying data objects 79 according to user command (specification).

Other applications and data display/exploration tools are suitable. The foregoing example use of the invention in a biotech data application is for purposes of illustration and not limitation.

2.1 Metadata and Definitions

The definitions that are presented in this section for SDL are generally independent from any particular implementation. Nevertheless, since one of the main design criteria was to apply a non-intrusive design and utilize existing RDBMS architecture, the discussion will be oriented around the corresponding relational database concepts.

2.1.1 Domains. The term domain is commonly used in the database literature for the definition of data types and is for instance used by Codd (Codd, E. F. “A relational model for large shared data banks,” Comm. ACM 13(6):377-387, 1970) in his monumental paper on the relational model for databases. Most commercial relational implementations do however limit the scope of a domain to a specification for the storage of the underlying data type (Ramakrishnan, R. and Gehrke, J., Database Management Systems, 2nd ed. McGraw-Hill, 2000; ANSI documents, X., “The database Management Systems, 2nd ed. McGraw-Hill, 2000; ANSI documents, X., “The database language SQL,” Tech. Rep., American National Standards Institute, 1992) although recent object-relational extensions can be viewed as a mechanism to incorporate more logic into the data types (Stonebraker, M., Object-relational DBMSs: the next great wave/Michael Stonebraker with Dorothy Moore. Morgan Kaufman Publishers, Inc., 1996). In SDL, a domain is a high-level data type that is meant to encompass all the relevant information about the corresponding data. Each domain has several properties including:
Name and description.
Data type, e.g. DATE, NUMBER, or STRING or other complex data types.
Enumerable vs. infinity property.
Primary dimension.
Domain definition relation (“universe”) for enumerable domains.
Optional max and min range for infinite domains.
Language syntax support, e.g. compatible operators, taxonomies, methods and functions and other comparable domains.
Templates for translation of operators, methods, and functions to the corresponding RDBMS statements.
GUI support, e.g. dynamic library to facilitate data entry of domain values, support for choosing set-reports, and URL templates etc.

The above is not a comprehensive list of all the domain properties, but meant to emphasize the high-level nature of the SDL domains as compared to regular SQL data types. For instance, height and weight of individuals might be stored using the same number representation in the database, however, they are not comparable nor do they have the same range. Also, some of the domain properties such as GUI support and templates will vary depending on how the SDL system is implemented.

2.1.2 Dimensions. In the SDL terminology applicants refer to instantiations of domains as dimensions. Historically, the name dimension in SDL arises from the fact that a relation can be viewed as multi-dimensional coordinates. This is similar to the terminology in conventional OLAP systems where tables are called hyper-cubes and their columns dimensions and facts (Colossi et al. 2002). Applicants' definition of dimension has though more similarity with the terminology used by Agrawal et. al. (Agrawal, R. et al., “Modeling multidimensional databases,” Tech. Rep., IBM Almaden Research Center, San Jose, Calif., 1996) and in theory applicants do not make a distinction between dimensions and facts. However, applicants recognize that in practice the domain specification of each dimension will determine its usage. For instance, a dimension of a enumerable domain may not be eligible for calculations and dimension of an infinite domain does not fit well for hierarchical classification.

Applicants classify dimensions into several categories:
PD: Primary dimensions; they are equivalent to object-identifiers (OID) in OO systems and used as output and domain specification in SDL set-definitions. Only enumerable domains may have PDs associated with them. Primarykeys (PK) and foreign-keys (FK) in RDBMS 102 are typically mapped with corresponding primary dimension.
RD: Reference dimensions; they are equivalent to object-references. Each RD is of the same domain as a corresponding PD. RDs are typically mapped to FK in RDBMS 102.
AD: Attribute dimensions; these are dimensions that are neither PD nor RD but used to qualify objects.

It is a design issue where the difference is drawn between AD and RD. This issue touches indeed the heart of normalization and relational schema design as well as object design—object aggregation and composition (Cattell, R. G. G., Object data management: object-oriented and extended relational database systems, Addison-Wesley Publishing Company, Inc. 1994). As will be seen later in the examples, one of the key features of the invention SDL metadata is to abstract the underlying storage mechanism from the user.

2.1.3 Concrete relations. Concrete relations are defined in SDL as an unordered collection of two or more dimensions that are registered with the system. Each relation must have one and only one PD and each dimension can only appear once in each relation. When a concrete relation is defined, it is specified if the PD has a distinct constraint in the relation (primary key —PK).

A dimension name represent the role the corresponding domain plays in the given relation, however, unlike in Codd's 1970 terminology, relation names in SDL do not have any particular function but rather the so-called dimension fingerprint, i.e. the list of dimensions that defines the relation. Although there are no strict rules for the general structure of dimension names in SDL, a systematic naming convention for dimensions might be:
PDname.role or PDname.role.domain

Notice how the primary-dimension has to some extent replaced the role of the relation name in Codd's terminology. Another concept that is of importance in dimension naming is default dimension prefixing. Both within relations as well as in set definition expressions, the PD name can be used as a default prefix to the name of the other dimensions. Hence, the full name of a dimension does not have to be specified, although it is permissible.

2.1.4 Virtual relations. By definition, a virtual relation (VR) is a relation that is defined by a dimension fingerprint. The virtual relation is the main data abstraction in SDL and used to hide or encapsulate the storage implementation of the concrete data relations stored in the RDBMS 102. Based on how VR are implemented, they can also be used to provide access to only selected parts of data, based on scoping parameters such as user privileges etc. From the language perspective, virtual relations are pure logical constructs and are represented by the following notation:
[dₚ, dₐ, . . . , d_{z}] Ex. 1

A formal description of virtual relations requires the following definitions: Definition 2.1.1. Relation overlap: Two concrete relations are said to overlap if they have in common dimensions other than their primary dimension. Formally, two relations R₁,R₂2└Σ, where Σ is a superset that denotes the data schema, are said to overlap if and only if:
dₚ└R₁ [symbol] dₚ└R₂ [symbol] ∃d└R₁\R₁\{dₚ} [symbol] d└R₂, where dₚ represents their primary dimension. Applicants denote the overlap of two relations R₁ and R₂ with the Boolean function O(R₁,R₂).
   Definition 2.1.2. CRC and CDC: A concrete relation cluster (CRC) is a set of concrete relations in the schema, Σ, that through transitive closure can be linked through overlapping concrete relations in Σ. Formally, a set of concrete relations C⊂Σ is a concrete relation cluster if and only if:
∀R₁, R₂ └C, ∃S={r₁,r₂, . . . rₙ}⊂C, O(R₁,r₁) [symbol] O(r1,r2) [symbol] . . . [symbol] (rₙ,R₂)
   Likewise, a concrete dimension cluster (CDC) is a set of dimensions that form the relations in a CRC.

For the time being, applicants define a virtual relation which is valid for dimension fingerprints that are a single CDC. Later the definition will be augmented to include virtual dimensions as well as dimensions from multiple CDCs.

Definition 2.1.3. Virtual relation: Given a dimension fingerprint F that is a CDC with a primary dimension dₚ, the corresponding virtual relation is defined as π_{F}(∪Rᵢ), ∀Rᵢ└Σ where dₚ└Rᵢ. For concrete relations where ∃d└F [symbol] d∉Rᵢ the dimension values are substituted with “missing value” (NULL) in their tuples.

For the virtual relation in Ex. (1), the above definition is simply the projection of any relation with dₚ and any of the dimensions dₐ, d_{b}, : : : , d_{z}. This definition becomes clear as the description of how virtual relations are used and generated is presented. As mentioned in the previous section, there can be only one PD in each concrete relation and the same holds for virtual relations. Overlapping concrete relations must have the same constraint on the PD and the PD is assumed to be unique in the corresponding CDC if the relations have PK on the PD. Whether and how such uniqueness is ensured is implementation dependent.

Definition 2.1.4. Collections and singletons: Singletons are dimensions in a CDC in which the PD has a unique constraint (PK). Correspondingly, dimensions in a CDC that are not singletons are defined as collections.

In order to reveal the use of virtual relations, discussed next is how they can be integrated with the SQL language. For instance, consider selecting all the tuples in the virtual relation presented in Ex. (1):

| | |
|---|---|
| SELECT * FROM [ dₚ, dₐ, . . . , d_{z} ]; | Ex. 2 |

Notice how the statement in Ex. (2) resembles a regular SQL statement, apart from the FROM clause which has square-brackets denoting a virtual relation. The above statement is the first example applicants present in a language that is referred to herein as SSDL which is a combination of SQL and SDL. Similarly, in SSDL projection, selection and joins are defined in the following manner:

| SELECT a.<dₐ>, b.<d_{b}> FROM [dₚ, dₐ] AS a, [dₚ, d_{b}] AS b | |
|---|---|
| WHERE a.<dₚ> = b.<dₚ>; | Ex. 3 |

In addition to the special virtual relation notation, introduced here are angle brackets to refer to SDL dimensions from within SQL. This type of mapping between SDL and SQL metadata is instrumental to enable the two languages to be merged. Both the square-brackets and the angle-brackets are easily identified from standard SQL language constructs and they ensure that the SDL dimension naming conventions of using dotted notation does not conflict with the use of dots in SQL. Apart from these new language constructs, there should be nothing that is not straightforward for a reader familiar with SQL and the following sections will use this type of SSDL notation to explain the semantics of SDL in the following sections.

2.2 RDBMS Implementation

Previously, applicants have stated that the SDL language should in principle be independent from the underlying implementation. While that is true, applicants recognize that the success of SDL depends heavily on its performance, flexibility, and compatibility with existing database systems. The predecessor to the present invention and related applications SDL system was implemented such that Boolean statements were compiled into Java source code that was compiled and executed on a specific memory-based data structures, representing clinical diagnostic codes and measurements. These initial data structures provided only limited flexibility to work with event based clinical data as well as other more sophisticated data types. Therefore, the need for relational data structures (records) arose quickly and a set definition language based on relations was formalized. In the process, the system 100, 104 was redesigned on top of a RDBMS 102, 103. FIG. 1 shows the basic architecture of the SDL system 100, 104. Not only does this architecture provide for increased scalability, improved transaction handling and better overall performance than the previous Java implementation, but also, with the appropriate metadata mapping most existing legacy data can be used with the SDL system 100, 104.

The non-intrusive design approach applicants have used for the SDL system 100, 104 resembles several other systems in the literature, e.g. an LDAP implementation (Shi, S. et al., “An enterprise directory solution with DB2,” IBM Systems Journal 39(2):360-383, 2000), for XML and XQuery support (Funderburk, E. et al., “XTABLES: Bridging relational technology and XML,” IBM Systems Journal 41(4):616-641, 2002, and Chamberlin, D., “XQuery: An xml query language,” IBM Systems Journal 41(4):597-615, 2002), and for object querying (Fahl, G. and Risch, T., “Query processing over object views of relational data,” The VLDB Journal 6(4):261-281, 1997).

Various implementation schemes exist for decision support systems such as conventional OLAP systems (Colossi et al. 2002) and in general the physical organization of data structures plays a crucial role in determining their performance and flexibility. For instance, the cost of calculating standard multi-dimensional aggregates (Gray, J. et al., “Data cube: A relational aggregation operator generalizing group-by, cross-tab, and sub-totals,” J Data Mining and Knowledge Discovery 1(1):29-53, 1997) has been shown to be highly determined by the types and the number of disk reads as well as the memory utilization (Harinarayan et al. 1996; Zhao et al. 1998). Because of a well standardized query language and flexibility for ad-hoc queries, significant commercial effort has focused on integrating conventional OLAP warehouse capabilities with RDBMS (ROLAP) (Informix Corporation, “Informix Extended Parallel Server 8.3,” Informix Corporation, Menlo Park, Calif., Technical White Paper, 1999; Red Brick Systems, Inc., “Star schema processing for complex queries. Red Brick Systems, Inc., Los Gatos, Calif., Technical White Paper, 1997; Miszczyk, J. et al., “DB2/400: Mastering Data Warehousing Functions,” IBM Corporation, International Technical Support Organization, Rochester, Minn., Technical Red Book, 1998; and Oracle Corporation, “Oracle8i for Data Warehousing,” Oracle Corporation, Redwood Shores, Calif., Technical White Paper, 1999b). Applicants believe that the ROLAP architecture provides a good compromise between speed and expressive power and the flexibility that is highly important in life-sciences data analysis.

Several approaches have been proposed and compared for relational storage organization, including binary representation (Missikoff, M., “A domain based internal schema for relational database machines,” In Proceedings of the 1982 ACM SIGMOD International Conference on Management of Data, Orlando, Fla., 215-224, 1982; Copeland, G. P. and Khoshafian, S. N., “A decomposition storage model,” In Proceedings of the 1985 ACM SIGMOD International Conference on Management of Data, Austin, Tex., pp. 268-279, 1985; Khoshafian, S. et al., “A query processing strategy for the decomposed storage model, In Proceedings of the Third International Conference on Data Engineering, Los Angeles, Calif., pp. 636-643, 1987; and. Shi et al. 2000), horizontal and vertical representation (Agrawal, A. R. et al., “Storage and querying of e-commerce data,” In Proceedings of the 27th VLDB Conference, 2001, Roma, Italy) as well as several other related schemes (Florescu, D. and Kossman, D. “A performance evaluation of alternative mapping schemes for storing XML data in a relational database,” Tech. Rep., INRIA, France 1999; and Nadkarni and Brandt 1998). Although there is no single answer to the question what is the best data layout in RDBMS, because it depends largely on the query types, applicants have chosen multi-table layout as the primary layout approach. This approach is somewhat similar to the shared-inlining (Shanmugasundaram, J. et al., “Relational databases for querying XML documents: Limitations and opportunities,” in VLDB '99, Proceedings of 25th International Conference on Very Large Data Bases, Edinburgh, Scotland, UK, 1999, 302-314) and the relational DTD approach (Tian, F. et al., “The design and performance evaluation of alternative XML storage strategies,” ACM Sigmod Record 31(1):5-10, 2002), where each relation (attribute combination) is stored in a separate table, and these layouts have been found to give the overall best performance for various XML queries.

The “high dimensionality” of clinical and life-science data introduces challenges for system and database developers. Pivotal like schemas have typically been proposed to solve the problem of variable attribute numbers with a static RDBMS schemas (Agrawal et al. 2001; Nadkarni and Brandt 1998). Although there are scenarios where vertical designs are useful, applicants believe that it is of importance to structure the system such that it has the flexibility to store data in multiple tables. Applicants' initial experience with a vertical RDBMS data layout indicated for instance that worst case scenarios, such as when the RDBMS chooses a full table-scan on a single table, can be much more costly in the vertical schema layout than in the multi-table layout, especially when the index does not fit into the main memory. Similar results have been observed where entity attribute value (EAV) design was compared to conventional schema, and it was found to be up to five times slower for some typical clinical queries (Chen, R. S. et al., “Exploring performance issues for a clinical database organized using an entity-attribute-value representation, Journal of the American Medical Informatics Association 7(5):475-487, 2000). Query optimization in RDBMS, especially for joins, has attracted enormous attention in database research literature in the past and continues to do so (Mishra, P. and Eich, M. H., “Join processing in relational databases,” ACM Comput. Surv. 24(1):63-113, 1992; Pirahesh, H. et al., “Extensible/rule based query rewrite optimization in Starburst,” In Proceedings of the 1992 ACM SIGMOD International Conference on Management of Data, ACM Press, pp. 39-48, 1992; Paulley, G. N. and Larson, P.-A., “Exploiting uniqueness in query optimization,” In Proceedings of the 1993 Conference of the Centre for Advanced Studies on Collaborative Research, IBM Press, pp. 804-822, 1993; Leung, T. Y. C. et al., “Query rewrite optimization rules in IBM DB2 universal database,” In Readings in database systems, 3rd ed., Morgan Kaufmann Publishers, pp. 153-168, 1998; Haas, L. M. et al., “SEEKing the truth about ad-hoc join costs,” The VLDB Journal 6(3):241-256, 1997; and Slivinskas, G. et al., “Bringing order to query optimization,” ACM Sigmod Record 31(2):5-14, 2002). It is important for optimizers to have statistics on the data in order to choose the right execution plan (Wang, H. and Sevcik, K. C., “A multi-dimensional histogram for selectivity estimation and fast approximate query answering,” In Proceedings of the 2003 Conference of the Centre for Advanced Studies Conference on Collaborative Research, IBM Press, 328-342, 2003). In most systems, the granularity of statistics and indices is based on tables and their columns. Thus, by enforcing all data that may be of different nature into one or very few tables, many of the built in features in advanced RDBMS are set aside. An example would be the option to use different index types for data of different nature. Furthermore, tables often partition data into logical units based on which attributes need to be used together in queries, thereby often enabling better caching and memory utilization in the database server than with a single table schema.

In one embodiment, the SDL data schema is open or dynamic and only the SDL metadata schema remains fixed. Each dimension in a relation is stored in a separate table column. This configuration makes the SDL system compatible with star and snowflake-schemas that are common in many data warehouses (Kimball, R. and Strehlo, K., “Why decision support fails and how to fix it,” SIGMOD Rec. 24(3):92-97, 1995 and Murphy et al. 1999). This star-schema topology has been studied extensively with respect to conventional OLAP analysis and multiple storage, indexing, and join strategies have been presented to make them efficient (ONeil, P. and Graefe, G., “Multi-table joins through bitmapped join indices,” SIGMOD Rec. 24(3):8-11, 1995; Li, Z. and Ross, K. A., “Fast joins using join indices,” The VLDB Journal 8(1):1-24, 1999; Bizarro, P. and Madeira, H., “The dimension-join: A new index for data warehouses,” In XVI Brazilian Symposium on Databases, 2001; Stockinger, K. et al., “Strategies for processing ad hoc queries on large data warehouses,” In Proceedings of the 5th ACM International Workshop on Data Warehousing and OLAP, ACM Press, pp, 72-79, 2002; and Padmanabhan, S. et al., “Multi-dimensional clustering: a new data layout scheme in DB2,” In Proceedings of the 2003 ACM SIGMOD International Conference on Management of Data, pp. 637-641, 2003). In the future, applicants also plan to support vertical and pivoted schema layout where multiple dimensions are stored in a single table column. The underlying storage implementation will nevertheless continue to be abstracted from the user. These alternative implementation details will be presented in future publication.

2.2.1 Virtual relation generation. Here applicants present how virtual relations can be generated using the multi-table schema implementation for SDL. Suppose we define a schema, Σ, by registering two tables, Table1 and Table2, and map their columns with dimensions in the following manner:

Table1(C1,C2,C3) ⇄ [ dₚ, dₐ, d_{b} ]

and

Table2(C1,C2,C3,C4) ⇄ [ dₚ, dₐ, d_{b}, d_{c} ]

Now consider the following SSDL code for using a virtual relation and the corresponding SQL translation in Ex. (5):
SELECT * FROM [dₚ, d_{b}]; Ex. 4

is equivalent to

| SELECT * FROM ( SELECT C1, C3 FROM Table1 | |
|---|---|
| UNION ALL SELECT C1, C3 FROM Table2 ); | Ex. 5 |

Similarly, in order to generate [dₚ, d_{b}, d_{c}] the following SQL code is used:

| SELECT * FROM ( SELECT C1, C3, NULL FROM Table1 | |
|---|---|
| UNION ALL SELECT C1, C3, C4 FROM Table2 ); | Ex. 6 |

Notice that when there are no constraints specified on the virtual relation, in accordance with the definition in section 2.1.4, there will be minimum one tuple for every possible value of the PD. Also, consider an example where there is a constraint on a dimension in the virtual dimension:
SELECT * FROM [dₚ, dₐ, d_{c}=constant]; Ex. 7
   which is equivalent to
SELECT * FROM [dₚ, dₐ, d_{c}] WHERE <d_{c}>=constant; Ex. 8

The SSDL statement in Ex. (7) can be translated into the following SQL code:

SELECT C1, C2, C4 FROM Table2 WHERE C4 = constant; Ex. 9

Notice that only Table 2 contains tuples that can possibly fulfill the criteria in Ex. (7), assuming that the constant is not NULL. Thus, as seen in Ex. (9), for performance reasons, tables that cannot contain tuples that fulfill the necessary predicates can be eliminated from the union. If the constant in Ex. (7) equals NULL the translation is:

SELECT * FROM ( SELECT C1, C2, NULL FROM Table1
UNION ALL SELECT C1, C2, C4 FROM Table2 WHERE C4 =

| | |
|---|---|
| NULL ); | Ex. 10 |

As shown above, the SDL and the SSDL compiler will determine it from the context, i.e. the predicates that are applied to the dimensions, which tables it is necessary to include in the VR. There are cases where one is interested in tuples where each dimension except the PD equals NULL. The description of how such virtual relations are generated in practice is given later.

One could argue that to a certain extent one has lost track of the data by “throwing away” the relation name. The storage relation name can however be easily introduced into SDL metadata. For instance, one could create a “system attribute” that is to be part of all virtual relations, e.g.:

| | |
|---|---|
| SELECT * FROM [ dₚ, d_{b}, sys.table ]; | Ex. 11 |

which would be translated to the following:

SELECT * FROM (SELECT C1, C3, “Table1” FROM Table1
UNION ALL SELECT C1, C3, “Table2” FROM Table2);

Ex. 12

Constraints can then be applied to the dimension sys.table in a similar manner as in Ex. (7) in order to select data from a particular table. For this to be efficient in practice where there are multiple tables, the constraint may have to be evaluated before the table union is generated. This method is currently also used to implement project scope on data.

There is an important difference between SDL dimensions and conventional RDBMS columns. Dimensions can be mapped to multiple different columns, as long as they belong to different tables or views. Likewise, the same column can be mapped with multiple SDL dimensions and a table or view can be mapped multiple times, for relations with different PDs. Similarly, there is a difference between VR and regular tables or views in RDBMS. Virtual relations do not have names as such but are dynamic relations identified from their dimension fingerprint and collected at runtime.

3. Language Introduction

Because the SDL language design is heavily shaped by life-science use-cases, while the following provides a formal introduction to the syntax, it will illustrate the language using example queries from the life-science domain. Furthermore, since the SDL language was designed to translate easily to SQL statements, the following will in many cases present the corresponding SQL translations both to contrast the two languages as well as to explain the semantics of SDL.

3.1 Basic Set Definitions

A general SDL statement defines a set on a given domain specified with its primary dimension (PD) and an expression with predicates on dimensions that belong to any relations with the corresponding PD, e.g.:

{ dp | expression } = { dₚ | p(dₐ) } = { dₚ | dₐ = c }

Ex. 13

The semantics of this simple example are defined with the following SSDL (SQL) statement:

| SELECT DISTINCT <dₚ> FROM [ dₚ, dₐ ] | |
|---|---|
| WHERE <dₐ> = c; | Ex. 14 |

Thus, the definition in Ex. (13) specifies the set of all the dₚ that exist in a virtual relation with dₐ which value is equal to the constant c. It should be noted that there is no assumption made about the multiplicity of dp in the relation and therefore there is an implicit “exist” clause on the predicate. If a dimension appears in an expression without a predicate, it is interpreted as d !=NULL, i.e. that the dimension has a defined value.

The structure of an SDL statement resembles a formal mathematical set notation and has some striking similarities with the notation used for tuple relational calculus (TRC) (Codd, E. F., “Relational completeness of data base sub-languages,” In Data Base Systems, R. Rustin, Ed., Prentice Hall, 1972) and domain relational calculus (DRC) (Lacroix, M. and Pirotte, A., “Domain-oriented relational languages,” In Proceedings of the Third International Conference on Very Large Data Bases, Oct. 6-8, 1977, Tokyo, Japan. IEEE Computer Society, pp. 370-378). There are however important differences, most notably that relational joins based on the PD are implicit and do not have to be defined explicitly as will be seen in later examples. In that regard, SDL has some similarities with object query calculus (Straube, D. D. and Özsu, M. T., “Queries and query processing in object-oriented database systems,” ACM Trans. Inf. Syst. 8(4):387-430, 1990 and Bertino, E. et al., “Object-oriented query languages: The notion and the issues”, IEEE Trans. Knowl. Data Eng. 4(3):223-237, 1992), although their data models differ.

3.1.1 Conjuncts. In order to put things into context with real application scenarios, imagine a task typical for a clinical researcher, i.e. to find all individuals that have some specified characteristics. To start with, consider an SDL statement to find all male individuals born after the year 1966:

| | |
|---|---|
| { pid \| sex = “male” AND yob > 1966 } | Ex. 15 |

In this example, the PD is a patient identifier, pid, and the other two dimensions are self-explanatory. In a typical setting where a system is by default configured to define patient sets, the user does not have to enter the full SDL statement, but only the expression defining the individuals. In the example above, this may have been achieved almost fully by two drag-and-drops into an SDL query editor, one drag for each of the attributes, as well as a single button click to insert the “AND” keyword and few keystrokes for typing “>1966”.

For the query in Ex. (15) to be valid, the SDL system must have registered one or more relations storing pid as well as sex and yob. For the time being, assume that they exist in a single concrete relation and then the corresponding SSDL translation is:

| SELECT DISTINCT <pid> FROM [ pid, sex, yob ] WHERE | |
|---|---|
| <sex> = “male” AND <yob> > 1966; | Ex. 16 |

To emphasize the similarity between the SDL syntax and mathematical set notation, the above conjunctive query is equivalent to the following set definition, i.e. the intersection of two sets:

{ pid | sex = “male” } ∩ { pid | yob > 1966 } Ex. 17

It is important to emphasize that although Ex. (15) and Ex. (17) are semantically equivalent, they suggest two different SSDL translations. The natural translation of the latter one is:

SELECT DISTINCT <pid> FROM (
SELECT <pid> FROM [ pid, sex ] WHERE <sex> = “male”
INTERSECT
SELECT <pid> FROM [ pid, yob ] WHERE <yob> > 1966 );

Ex. 18

In Ex. (16) there is simply one cursor to the virtual relation [pid,sex,yob] whereas in Ex. (18) there are two separate cursors, one on the relation [pid, sex] and another cursor on the relation [pid, yob]. For expressions with only singleton attributes these are always semantically equivalent, but this requires certain assumptions for collection attributes.

3.1.2 Disjuncts. Of course, SDL also supports expressions with disjunctive terms and parenthesis to define operation precedence in general Boolean expression, e.g.:

| { pid \| ( sex = “male” OR yob > 1966 ) AND yod < 2000 } ={ | |
|---|---|
| pid \| sex = “male” AND yod < 2000} ∪ { pid \| yob > 1966 | |
| AND yod < 2000 } | Ex. 19 |

This relatively simple example shows how the distribution law of mathematical set theory can be used to rewrite an SDL statement into two SDL statements that are in conjunctive normal form (CNF) (Ramakrishnan and Gehrke 2000) The SDL optimizer uses similar rewrite rules to rewrite SDL statements into form that is more easily translated to efficient SQL code.
3.2 Collections

Even though the SDL language has more succinct notation than SQL in the above examples, these are oversimplified cases that do not highlight the benefits of SDL. The fact that individuals only have a single gender, year of birth, and year of death attributes makes the data modeling very easy in RDBMS and the data can be stored in a single relational table. To further explain this important point, consider an example where individuals have to be selected based on two diagnostic codes, e.g. using the ICD10 coding system. In an over simplistic setting, the data could be modelled in a spreadsheet like way, by storing the two diagnosis in two separate columns, i.e. a relation with a personal identification number and two diagnostic codes. Then the SDL expression could look like the following:

diag1 =: “cancer.a” AND diag2 =: “cancer.b” Ex. 20

Introduced here is a graph or hierarchy descendant comparison operator “=:” which is very useful in many life-science data analysis that involves taxonomical classification. This operator defines a predicate that is true for all domain values which values are equal to a node or its sub-nodes in a directed acyclic graph (DAG). Various other domain specific operators can of course be built into SDL. In general, the SDL system enables the system administrators to specify the translation of SDL predicates into SQL predicate for any given domain. The implementation applicants demonstrate here enables this operator to be implemented efficiently on a RDBMS that supports standard B-tree indexing and wildcards, both for balanced as well as unbalanced hierarchies:

SELECT DISTINCT <pid> FROM [ pid, diag1, diag2 ] WHERE
(<diag1> LIKE “cancer.a*” AND (<diag1> = “cancer.a” OR
<diag1> LIKE “cancer.a.*”)) AND (<diag2> LIKE “cancer.b*”
AND
(<diag2> = “cancer.b” OR <diag2> LIKE “cancer.b.*”));

Ex. 21

Apart from the expansion of the comparison operator the SQL statement is still relatively easy to read and understand, because it does not involve any join operation. This particular implementation assumes that the domain values are of the form level1.level1 . . . Also, this implementation is much more efficient than the “straightforward” implementation d LIKE “r.a.*” OR d=“r.a”. The straightforward translation leads to two scans on the index per predicate as compared to one in the mapping used in Ex. (21). Therefore, with multiple predicates it can lead to exponential complexity and cost of the query.

Although the above examples are not too uncommon in settings that involve survey based data, they are extremely limited since the “horizontal data layout” cannot be extended to real scenarios where individuals have different number of diagnosis or the number of diagnosis is very high. This is most often the case with event based clinical data. The problem gets even bigger when more data needs to be used, such as clinical measurements or information on drug intake. In such settings, a much better solution in a clinical warehouse architecture is to model the data with multiple fact tables, one for each type of attributes. Thus, referring back to Ex. (21), all the diagnosis are kept in the same table column in different rows as compared to separate columns for the two diagnosis in Ex. (21). Typically, other dimensions would be stored in the diagnostic table as well, such as the date of diagnosis, information on the doctor, the hospital etc. With this data model, the corresponding SDL expression is:

| | |
|---|---|
| diag =: “cancer.a” AND diag =: “cancer.b” | Ex. 22 |

Notice that this SDL expression is almost exactly like the one for the horizontal data layout, the difference being that the same AD is used twice. This property of the invention SDL language, i.e. to allow the same attribute to be used multiple times and refer to different tuples in a relation without explicitly naming multiple cursors, makes query composition in SDL extremely well suited for drag-and-drop GUI support. Another aspect that is worth emphasizing again is the implicit understanding that only these two conditions need to exist. Individuals that may have other diagnosis in addition to cancers of type “a” and “b” will also be in the set. For comparison, now the SSDL query gets more involved and much harder to understand:

SELECT DISTINCT <pid> FROM [pid, diag] AS d1, [pid, diag]

AS d2

WHERE (d1.<diag> LIKE “cancer.a*”) AND
(d2.<diag> LIKE “cancer.b*”) AND d1.<pid> = d2.<pid>;

Ex. 23

This SSDL query is much more complicated than the corresponding SDL query, because a join needs to be used with a corresponding complication in the FROM clause (i.e., two cursors have been introduced) and there is an additional “where” constraint, to ensure that the diagnoses belong to the same individual. This “implicit join constraint” that is based on the specified PD is an important feature in the SDL language that simplifies the syntax of ad-hoc queries where multiple predicates are needed on the same attribute or attributes that may reside in different relations. This property of the language also sets it apart from SQL as well as TRC and DRC.

3.3 Record-Operators and Automatic Record-Locking

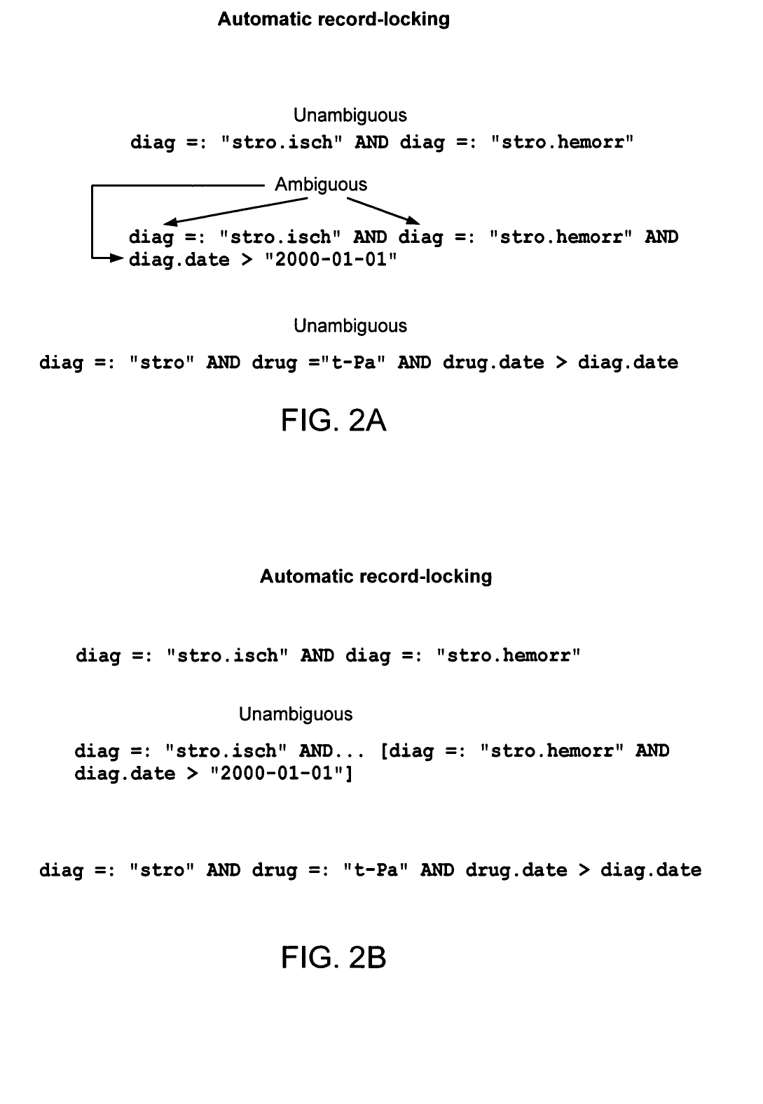

Relations can be used to represent multi-attribute objects, often referred to as records or structures, which are necessary in most real-life scenarios. In the previous section only expressions that were based on singleton attributes were presented, therefore, the treatment of relations (records) did not create any semantic ambiguity. However, the previous section showed how the same dimensions can occur in multiple predicates within the same SDL expression. Thus, it is necessary to clarify how SDL treats collections of records, the record-operator, and the overall semantics of records in SDL. Selected examples follow and correspond to FIGS. 2a-2b.

First consider defining a set of patients that have been diagnosed with two types of stroke, e.g. ischemic and hemorrhagic:

diag =: “stro.isch” AND diag =: “stro.hemorr” Ex. 24

In this expression there is no assumption made about the time occurrence of these diagnostic events. For start, assume that one wants the hemorrhagic diagnosis to have happened before the year 2000:

| diag =: “stro.isch” AND diag =: “stro.hemorr” AND | |
|---|---|
| diag.date > “2000-01-01” | Ex. 25 |

This expression is ambiguous and badly defined because to the SDL system, it is not clear whether the diag.date attribute refers to the ischemic stroke or the hemorrhagic stroke event as illustrated in FIG. 2a. If the system would keep some kind of left-right preference, this might have been resolved, however, in concordance with standard conventions in interpretation of Boolean expressions, the order of terms in conjuncts does not matter. Thus, to resolve this ambiguity, the invention SDL language provides a record-locking operator, e.g.:

| [ diag =: “stro.hemorr” AND diag.date > “2000-01-01” ] | |
|---|---|
| AND diag =: “stro.isch” | Ex. 26 |

FIG. 2b is illustrative.

Constraints within the square-brackets are guaranteed to be enforced within the same record (relational tuple). Now imagine defining a patient set for those who have received a certain medication after a stroke diagnosis. An example of such an SDL expression is:

diag =: “stro” AND drug = “t-Pa” AND drug.date >

| | |
|---|---|
| diag.date | Ex. 27 |

The last constraint ensures that the medication follows a stroke diagnosis. Here the SDL compiler will automatically recognize that the dimensions diag and diag.date come from the same relation based on registered relations in the metadata and similarly recognize the relation for the dimensions drug and drug.date. Furthermore, the compiler will use automatic record-locking and only introduce two SQL cursors. The SSDL translation of Ex. (27) is:

SELECT DISTINCT d1.<pid> FROM [pid, diag, diag.date] AS

d1,

[pid, drug, drug.date] AS d2 WHERE
(d1.<diag> LIKE “stro*”) AND d2.<drug> = “t-Pa” AND
d2.<drug.date> > d1.<diag.date> AND d1.<pid> = d2.<pid>;

Ex. 28

This translation of Ex. (27) provides the “expected” meaning and gives the most intuitive semantics for SDL expressions with collection attributes. This translation approach has also interesting performance benefits for expressions with only singleton attribute predicates and is a special case of join elimination (Cheng, Q. et al., “Implementation of two semantic query optimization techniques in DB2 universal database,” In VLDB'99, Proceedings of 25th International Conference on Very Large Data Bases, Sep. 7-10, 1999, Edinburgh, Scotland, UK, M. P. Atkinson, M. E. Orlowska, P. Valduriez, S. B. Zdonik, and M. L. Brodie, Eds. Morgan Kaufmann, 687-698). Most current commercial SQL optimizers do not implement this type of cursor reduction based on the semantic equivalence of queries. If however the user wants to enforce the “unexpected” meaning, he can explicitly indicate that the diagnosis and drug attributes are from separate tuples and write:

[diag =: “stro”] AND [drug =: “t-Pa”] AND drug.date >

| | |
|---|---|
| diag.date | Ex. 29 |

In this example, the SDL compiler will use four SQL cursors, as compared to two cursors in Ex. (27), hence it will also have longer execution time. Here, the meaning of the query is to find individuals who have been diagnosed with stroke, have received t-Pa medication and have received some drug after being diagnosed. A concluding remark on this example is that the predicate on the dates might still be satisfied for the same two tuples that fulfill the other two predicates and in general, for arbitrary predicates, p, the following holds:

| | |
|---|---|
| {dₚ_{_{\|}}\|[pₐ(dₐ) AND p_{b}(d_{b})]} [symbol] {dₚ\|[pₐ(dₐ)] AND [P_{b}(d_{b})]} | Ex. 30 |

Notice that in order to ensure that the predicates on the dates in Ex. (29) are fulfilled by different tuples than the other predicates, either negation or binding variables have to be used. This is the subject of next sections.
3.4 Binding Variables

Analysis of longitudinal clinical data often requires the notion of time to be incorporated into expressions. If the time is explicitly incorporated into the data model, binding variables can be used to enable sophisticated time based analysis. An example, based on clinical event analysis as Ex. (27), is the case where the patient definition requires two consecutive diagnoses of different types of stroke, ischemic and hemorrhagic respectively. In such case, multiple references to diagnostic dates will become ambiguous. To resolve that, the record-operator is used to enforce constraints within the same relation:

| [diag = “stro.isch” AND $d := diag.date] AND | |
|---|---|
| [diag = “stro.hemorr” AND diag.date > $d] | Ex. 31 |

Contrast this example with Ex. (27) where constraints were enforced automatically for the relations [diag, diag.date] and [drug, drug.date], respectively. For clarification of the SDL syntax and for comparison with SQL, the corresponding SSDL query is:

SELECT DISTINCT d1.<pid> FROM [pid, diag, diag.date] AS

d1,

| [pid, diag, diag.date] AS d2 WHERE d1.<diag> = “stro.isch” | |
|---|---|
| AND d2.<diag> = “stro.hemorr” AND d2.<date> > d1.<date> | |
| AND d1.<pid> = d2.<pid>; | Ex. 32 |

Obviously, the SQL syntax is much harder to grasp than the corresponding SDL expression, even without the hierarchy comparison operator. Also notice that this is an example where the conjunctive constraint cannot be implemented with the INTERSECT keyword in SQL because of the binding variable, i.e. the constraints are correlated.

To further demonstrate the use of binding variables in SDL, presented next is a query where one is interested only in individuals diagnosed with two types of ischemic stroke, prior to t-PA medication:

[diag =: “stro.isch.throm” AND $d1 := diag.date] AND
[diag =: “stro.isch.embol” AND $d2 := diag.date] AND
[drug =: “t-Pa” AND drug.date > $d1 AND drug.date > $d2]

Ex. 33

Here, the record-operator has been used again, because the diagnosis attribute is used twice and it needs to be clarified whether $d1 refers to the date in a relation with thrombosis stroke or embolic stroke. The record-operator is therefore used to specify which attributes refer to the same relation. In this way, the invention SDL language is a relational language just like SQL.

An important subject with regard to binding variables is their scope within expressions. In general, binding variables only have scope within a conjunct and not across disjuncts.

3.5 Negations

As mentioned earlier, there is an implicit exist clause on predicates in SDL. This is important to keep in mind, especially when negation is used in expressions with predicates on collection attributes. As an example consider the following expression:

| | |
|---|---|
| diag =: “stro” AND NOT sex = “male” | Ex. 34 |

Since each individual has only a single sex attribute, this expression is equivalent to an expression where a negation operator, !=, is used instead of the negation keyword NOT:

| | |
|---|---|
| diag =: “stro” AND sex ! = “male” | Ex. 35 |

However, for typical collection attributes like diagnosis this equivalence no longer holds, i.e.:

| { pid \| sex = “male” } \ { pid \| diag =: “stro” } | |
|---|---|
| { pid \| NOT diag =: “stro” AND sex = “male” } ≠ | |
| { pid \| diag ! =: “stro” AND sex = “male” } | Ex. 36 |

The reason for this is the fact that the latter expression only requires males with some diagnosis that differ from stroke whereas the former defines the set of males that have never been registered with a stroke diagnosis. Another way of stating this it the following:

{ dₚ | NOT p(d) } = { dₚ | [symbol] p(d) }

[symbol]

{ dₚ | p(d) } = { dₚ | ALL [ p(d) ] } Ex. 37

Of crucial importance here is that, based on applicants' definitions for VR above, “missing” values are equal to the NULL value and that all predicates on NULL evaluate to unknown.

Back to the clinical example, in plain English, the above two SDL statements say that if a set of individuals that do not have strokes is always the same as the set of individuals that have a diagnosis different from stroke, it is equivalent to saying that for those individuals that do have strokes, it is their only diagnosis, as specified by the ALL keyword. The ALL operator in SDL effectively changes the default interpretation of predicates in SDL, i.e. that a predicate only needs to be true for some or any tuple with a given value of the PD, and insists that it is true for all values. The following equivalence holds for any expression with the ALL operator. It is also possible to define the semantics of ALL in SDL with the ALL operator in SQL or by using SDL aggregates operators. If available, the SDL translator uses the ANY operator in SQL, since it gives the SQL optimizer the most semantic information for optimization.

{ dₚ | ALL[p(d)] } = { dₚ | ([p(d)] AND NOT [ [symbol] p(d)]) }

Ex. 38

Regardless of whether a predicate is on a collection attribute or not the following equality is always true with the exception of correlated predicates as shown in the following examples:

{ dₚ | pₐ(dₐ) AND NOT p_{b}(d_{b}) } = { dₚ | pa (dₐ) } \

| | |
|---|---|
| { dₚ \| p_{b}(d_{b}) } | Ex. 39 |

The above rewrite does indeed reveal how the SDL compiler translates negations into SQL code, i.e. it generates two SQL statements and uses the EXCEPT or the MINUS keyword to implement set-minus between their outputs. An interesting feature in SDL is the fact that expression that involve only negations are also possible, although at first, given the implementation detail above, one would think that a set-minus could not be generated. To better understand this issue consider the following SDL statement equality:

{ pid | NOT [diag =: “stro” AND NOT diag.date >

“2000-01-01”] }

| = { pid \| pid ! = NULL } \ { pid \| [diag =: “stro” | |
|---|---|
| AND !( diag.date > “2000-01-01” ) ] } | Ex. 40 |

There are two key observations to make from this example. Within the record operator, the NOT keyword has the same meaning as in the SQL language, i.e. it negates the tuple predicate. Negation in front of the record-operator is transformed into a set-minus. To enable that here, the query is rewritten, i.e. by adding a term to the conjunct that has a predicate that does not restrict the primary dimension. This is only necessary if there is no term without a negation in a conjunct. Applicants refer to this term as the domain universe or the domain definition set, i.e.:

{ pid | pid ! = NULL } ≡ { x ∈ dom( pid ) } Ex. 41

These examples illustrate that it is possible to specify unsafe queries in SDL and therefore shows that there are similarities between SDL and relational calculus, DRC in particular. The domain definition relation is precisely used to make sure that these “unsafe” queries evaluate quickly. In section 2.1.1 above, it was mentioned that a domain definition relation can be specified. Such a relation defines the domain for pid, dom(pid), and ensures that the generation of the virtual relation [pid] is efficient. That is, the domain definition relation is set to be the only “source” of information for which values are in a given domain. If the table DomPid is specified as the domain definition relation then [pid]is simply equal to SELECT PID AS<pid>FROM DomPID; as compared to a union of all relations with pid. This subject is related to materialized views in RDBMS. Thus, if a domain definition relation is specified, it overrides the standard generation of VRs. The translation of Ex. (40) is:

SELECT DISTINCT <pid> FROM [ pid ] EXCEPT
SELECT <pid> from [pid, diag, diag.date] WHERE
(<diag> LIKE “stro”) AND NOT (<diag.date> > “2000-01-01”);

Ex. 42

Before leaving the subject of negations in SDL, consider expressions with binding variables, i.e. correlated predicates. As an example consider:

[ diag =: “stro.isch” AND $d := diag.date ] AND
NOT [ diag =: “stro.hemorr” AND diag.date > $d ]

Ex. 43

This is an example where negations are used in conjunction with binding variables and collections. As the expression states, it specifies a set of patients that have never been diagnosed with hemorrhagic stroke after having been diagnosed with ischemic stroke. This type of expression is not directly applicable for a translation with a set-minus, because the conditions are correlated through the binding variable. The invention SDL compiler automatically recognizes this and translates it into a negation on a nested SQL statement, i.e.:

| SELECT DISTINCT a.<pid> FROM [pid, diag, diag.date] AS a | |
|---|---|
| WHERE (a.<diag> LIKE “stro.isch*”) AND NOT a.<pid> IN ( | |
| SELECT b.<pid> FROM [pid, diag, diag.date] WHERE | |
| (b.<diag> LIKE “stro.hemorr*” ) AND a.<pid>=b.<pid> | |
| AND b.<diag.date> > a.<diag.date> ); | Ex. 44 |

It is also possible to use the mathematical equality A\B=A\(A∩B),
to translate Ex. (43) into an SQL statement with the EXCEPT keyword, like in the earlier negation examples. Furthermore, a good SQL optimizer should not need the predicate a.<pid>=b.<pid> in order to optimize the nested SQL statement, since it is implicit in the IN constraint.
3.6 Nested Sets

Often, it can be useful to define constraints on attributes that are based on set membership or a collection of conditions. The SDL language supports this through conditions based on nested sets. Readers familiar with SQL recognize such language constructs as nested queries. First consider the most simplistic use of nested sets:

| | |
|---|---|
| { pid \| diag IN { “stro.isch”, “stro.hemorr” } } | Ex. 45 |

The above statement could just as well have been written in the following manner:

| | |
|---|---|
| { pid \| diag = “stro” OR diag = “stro.hemorr” } | Ex. 46 |

Although the above example shows an example of an alternative syntax that may lead to some size reduction in the expression, it is not the motivation for nested sets. Consider rather an example where there is a relation that associates an individual with its parents, e.g.

[ pid, father, mother ]:

{ pid | diag =: “stro” AND father IN { pid | diag =:

| | |
|---|---|
| “stro” } } | Ex. 47 |

This query finds all individuals that have been diagnosed with stroke that in addition have their fathers as members in the set of individuals that have stroke. The father attribute, which is associated with an individual, is indeed a reference (RD) or a pointer to another individual. The domain of the father RD will imply the domain of the nested set, i.e. the default output dimension. Thus, to make the syntax as concise as possible, the invention SDL system also allows this same expression to be written as:

| | |
|---|---|
| diag =: “stro” AND father IN { diag =: “stro” } | Ex. 48 |

The fact that the domain of each RD implies the PD is also used in the SDL GUI to support what applicants refer to as nested dimension drilling. Because of the naming convention of dimensions in SDL, it is natural to organize and present them visually in a hierarchical manner, i.e. all the dimensions that are related to a given PD are presented as leaves. Furthermore, a user can continue drilling from a RD into all the dimensions associated with the corresponding PD, select it and use drag-and-drop to compose nested queries in an easy manner. This provides similar experience to SDL query designers as for software developers that use OO-IDE tools to browse classes and their methods.

Now consider a more involved patient definition where in addition to having a relation that associates an individual with his parents, one has a relation that associates each individual with his children [pid, child]. With these relations in place one can write:

{ pid | diag =: “stro.isch” AND father IN { diag =:

“stro.isch” }

AND mother IN { NOT diag =: “stro” } AND child IN { sex =

“male”

| | |
|---|---|
| AND diag =: “stro.isch” } } | Ex. 49 |

Clearly, this expression finds all patients that have been diagnosed with ischemic stroke that in addition have fathers and one or more male children that have been diagnosed similarly, but also, have mothers who have never been diagnosed with stroke. Similar queries might be of interest in the study of paternally inherited diseases. Again, it is illustrative to contrast SDL with the corresponding SSDL statement:

SELECT DISTINCT d.<pid> FROM [pid, diag] AS d,
[pid, father, mother] AS p, [pid, child] AS c
WHERE d.<pid> = p.<pid> AND d.<pid> = c.<pid>
AND p.<father> IN (SELECT <pid> FROM [pid, diag] WHERE
<diag> =: “stro.isch”) AND p.<mother> IN (SELECT <pid>

FROM [pid]

EXCEPT (SELECT <pid> FROM [pid, diag] WHERE
<diag> =: “stro.isch”)) AND c.<child> IN
(SELECT <pid> FROM [pid, diag] WHERE <diag> =:

| | |
|---|---|
| “stro.isch”); | Ex. 50 |

Clearly, the succinct SDL notation of the present invention is much more intuitive and easily understood even though the “=:” operator is not expanded in the SQL code.

Nested queries are also very useful to form expressions with attributes from multiple types of objects, e.g. individuals and tissue samples. As an example of such, consider finding all male individuals that have DNA samples:

{ pid | sex = “male” AND sample IN { sid | type =: “DNA”

AND

location =: “roomA.freezer2” } } Ex. 51

In the above statement, the sample attribute (RD) that is associated with each individual in [pid, sample], references a sample identifier, sid. The samples can of course be classified with whatever attributes that are available on them in relations such as the sample type and information on storage location, as shown here.

As a final example, consider nested sets as qualifiers in multi-attribute relationship, i.e. a relation. Here applicants draw an example from the genomics field. Imagine that one wants to find all genes that are on the X chromosome that have protein sequence similarity above a certain threshold with any of the few hundred genes classified as gene protein coupled receptor (GPCR):

| { gene \| chrom = “X” AND [ protsim.score > 0.95 AND | |
|---|---|
| protsim.gene IN { gene \| ontology =: “GPCR” } ] } | Ex. 52 |

For this query to be possible, at least three relations must exist, one storing data on gene locations, another relation storing gene ontology information (possibly with multiple classifications per gene) and another relation which stores the results of protein sequence similarity between all of the genes in the genome. Typically, a minimum threshold needs to be set on the similarity score to avoid storing an entry for every combination of gene pairs ˜(40 k×40 k rows). Such similarity score could for instance be generated by applying the Blast algorithm (Altschul, S. F. et al., “Issues in searching molecular sequence databases,” Nature Genetics 6(2):119-129, 1994) on the protein sequences of the genes. Similarly, one could use binding variables o find genes with higher protein similarity tQ one class than another class of genes.
3.7 Aggregates

As emphasized in previous sections, SDL does support collections and for them it is valuable to be able to apply aggregate operators. The aggregate operators that are supported in SDL are similar to the SQL aggregate operators, but to some extent they also resemble aggregate operators in OQL (Brown, S. A. “The semantics of database query languages” Ph.D. thesis, University of Sheffield, UK 1999). Few examples reveal their behavior and usefulness. First consider a very simple example, i.e. finding all individuals with more than 10 diagnoses:

| | |
|---|---|
| { pid \| COUNT (diag) > 10 } | Ex. 53 |

Readers familiar with SQL will notice that there is no GROUP BY clause. It is implicitly specified in the language that grouping occurs for the primary dimension. Often, however, it is necessary to make more fine grained grouping. In the event based diagnoses case, one might be interested to find how many individuals have received more than 10 diagnoses per year. In such case, the user has to explicitly specify the additional grouping, e.g.:

| | |
|---|---|
| { pid \| [ COUNT (diag) > 10 GRBY diag.year ] } | Ex. 54 |

It is also possible to specify the grouping explicitly as GRBY pid, diag.year. Furthermore, the user might only be interested in the existence of this condition only within a specified time range:

[ COUNT (diag) > 10 WHERE diag.year > 2000 GRBY diag.year ]

Ex. 55

The WHERE keyword in SDL is identical to the corresponding keyword in SQL, however, SDL does not have any HAVING clause. Predicates that contain aggregate operators have to appear to the left of the WHERE keyword and they are automatically put into the corresponding HAVING clause in SQL:

| SELECT DISTINCT <pid> FROM [pid, diag, diag.year] WHERE | |
|---|---|
| <diag.year> > 2000 GROUP BY <pid>, <diag.year> | |
| HAVING COUNT (<diag>) > 10; | Ex. 56 |

Notice that grouping is not only by date, but both by date and individuals. The aggregate operator appears within the record-operator as compared to enclosing the record. This may seem unintuitive at first, however, it makes the application of multiple aggregates on the same relation and the use of aggregates in conjunction with binding variables more natural. Dimensions that appear in calculated expressions with aggregate operators (before the WHERE keyword) must be included in the GRBY clause unless they are enclosed with an aggregate operator themselves. This is comparable to the rules in SQL for which columns are listed in the GROUP BY clause and the SELECT clause. Applicants also considered the option of implying the dimension list for the GRBY clause.

Proceeding with two more examples: first, consider finding those individuals that have had more ischemic stroke diagnosis than hemorrhagic diagnosis:

| [ $c := COUNT (diag) WHERE diag =: “stro.isch” ] AND | |
|---|---|
| [ COUNT (diag) < $c WHERE diag =: “stro.hemorr” ] | Ex. 57 |

Secondly, consider finding genes which range of protein similarity scores with GPCR genes is within a specified limit:

[ MAX (protsim.score) - MIN (protsim.score) < 0.1
WHERE protsim.gene IN { gene | ontology =: “GPCR” } ]

Ex. 58

In this relatively complex example, it should be observed that multiple aggregate operators can be used within a record-operator as well as within the same calculated expression, i.e. the range constraint formed by using both MIN and MAX. Due to the nature of aggregation, dimensions that are not within an aggregate operator, but appear in a calculated expression with an aggregate, have to be listed in the GRBY clause. This is a similar requirement as in SQL.

The COUNT operator has an interesting behavior in SQL with regard to the treatment of NULLs (Ramakrishnan and Gehrke 2000). Because of the definition of VR in section 2.1.4, in SDL it is guaranteed that COUNT returns zero for dimensions that only have NULL associated with a given PD or no concrete tuples at all.

4. VIRTUAL DIMENSIONS

Earlier, virtual relations were introduced as the basic data abstraction mechanism in the invention SDL system. The SDL system also supports virtual dimensions (VD), i.e. dimensions that are not mapped directly to RDBMS columns, but generated dynamically based on certain rules and the associated metadata. Therefore, together VD and VR provide data storage abstraction in the invention SDL language.

There are several categories of virtual dimensions in SDL. Here applicants only focus on virtual dimensions that are related to nested dimension drilling, briefly mention in section 3.6. Virtual dimensions and nested dimension drilling provides object-oriented “feeling” for the underlying data and uses cascaded-dot-notation for dimensions like in path-expressions. Today, path-expressions are quite common in OO programming languages, in OQL (Kim, W. “A model of queries for object-oriented databases”, In Proceedings of the Fifteenth International Conference on Very Large Data Bases, Aug. 22-25, 1989, Amsterdam, The Netherlands, P. M. G. Apers and G. Wiederhold, Eds. Morgan Kaufmann, 423-432; Cattell 1994; and Stonebraker 1996), and more recently in XML languages (Chamberlin 2002). Path-expressions have had many incarnations since they originated in (Mylopoulos, J. et al, “A language facility for designing database-intensive applications” ACM Trans. Database Syst. 5(2): 185-207, 1980) and have been extended to provide more sophisticated navigation capabilities (Kifer, M., “Querying object-oriented databases,” In Proceedings of the 1992 ACM SIGMOD International Conference on Management of Data, ACM Press, 393-402 and den Bussche, J. V. and Vossen, G., “An extension of path expressions to simplify navigation in object-oriented queries,” In Deductive and Object-Oriented Databases pp. 267-282, 1993) For the time being, the aim is simply to use VD as an alternative syntax for nested queries and therefore only their simplest form is considered here.

Start with an SDL query similar to the one shown in Ex. (51):

| | |
|---|---|
| { pid \| sample IN { sid \| type = “DNA” } } | Ex. 59 |

With the VD notation, this same query can be written as:

| | |
|---|---|
| { pid \| sample.type = “DNA” } | Ex. 60 |

Notice the cascaded-dot-notation used in the representation of the sample.type VD. This dimension name is indeed generated by cascading the dimensions sample and type without their default prefixes. The full VD name with a prefix is equal to pid.sample.type. The translation of this query to SSDL is:

| SELECT DISTINCT a.<pid> FROM [ pid, sample.type ] AS a | |
|---|---|
| WHERE a.<sample.type> = “DNA”; | Ex. 61 |

Notice that the VR above is defined with a fingerprint that contains a VD. Before this SSDL statement is translated into SQL code it is expanded into the following code:

| SELECT DISTINCT a.<pid> FROM ( SELECT b.<pid>, c.<type> | |
|---|---|
| AS <sample.type> FROM [pid, sample] AS b, [sid, type] AS c | |
| WHERE b.<sample> = c.<sid> ) AS a | |
| WHERE a.<sample.type> = “DNA”; | Ex. 62 |

Thus, a VR that contains VD can be expanded into an SSDL statement that only contains concrete dimensions. Consider another expression that is very easy to generate with the support of nested dimension drilling and relates to the earlier genealogy query in Ex. (49):

| { pid \| diag =: “stro.isch” AND father.diag =: “stro.isch” | |
|---|---|
| AND NOT mother.diag =: “stro” AND child.sex = “male” | |
| AND child.diag =: “stro.isch” } | Ex. 63 |

This query is equivalent to Ex. (49) although the negation takes a slightly different form. An important feature of predicates on virtual dimensions in SDL is that they also apply for collections. An example of this is the child.diag VD which denotes any diagnosis of any child of a given individual. As with the standard treatment of predicates on concrete dimensions in SDL there is an implicit exist quantifier. In some object-query language implementations predicates on collections are not permitted, however, other require the quantifiers to be specified specifically (den Bussche and Vossen 1993 and Bertino et al. 1992) or require predicates with membership functions (Stonebraker 1996).

The VD notation provides an alternative syntactic way to express constraints that otherwise would require nested set notation, thereby increasing the conceptual conciseness and intuitiveness of the language. Furthermore, this syntax provides more power when used in conjunction with binding variables than nested sets, because scoping rules do not allow binding variables to be visible outside of a set definition. However, VD notation does not eliminate the need for nested sets, since expressions with predicates that involve aggregates and collection RD, may give unexpected results.

It is trivial to extend the cascaded-dot-notation for further levels of nesting, e.g. pid.father.father.yob would denote the year of birth attribute of the paternally related grandfather. Here yob is the last concrete dimension referred to in the VD name. To generate the virtual relation [pid, father.father. yob], the join [pid, father], [pid, father], and [pid, yob] are needed, where the joins take place between the RD and the corresponding PD. These relations specify a join-path that is used to generate the VR. In general, a join-path for a dimension can be generated by the following recursive algorithm, written as a function in a pseudo-language:

VRlist JoinPath(Dim pd, Tokenlist ld, rd) {

if size(rd) = 0 throw Exception;
if size(ld) = 0 and Dim(rd) in RelConcrDims(pd)

return VR(pd, Dim(rd));

if Dim(ld) in RelConcrDims (pd) return VR(pd,

Dim(ld)) + JoinPath(Pdim(Dim(ld) ), Null,
rd);

return JoinPath(pd, ld + Head(rd), Tail(rd));

}

The type VR is simply a virtual relation, and likewise VRlist represents an ordered list of such relations and the plus operator is used for list concatenation. The dot-separated dimension names are represented as token lists, and the function Dim(Tokenlist x) turns a token list into the corresponding dimension of type Dim. Similarly, the function RelConcrDims (Dim x) returns a set of all concrete dimensions related to the dimension x. The function Pdim (Dim x) returns the corresponding primary dimension based on the domain of x. Finally, the function Head(Tokenlist x) returns the first token in the list where as Tail (Tokenlist x) returns the list without the head. The reader can verify that JoinPath (pid, Null, father.father.yob) yields the correct result as shown above. Similarly, if Pdim (Dim (x)) throws an exception if x is not a valid RD, then JoinPath can also be used to validate dimension names.

4.1 The Minimum Cursor Principle

TABLE I
The join-paths for the individual dimensions in Ex. (64)
with the VRs for each join-level shown in the upper part
of the table. The lower part shows the extended virtual
relations (CDC) and their cursor names for each join-level
based on the minimum cursor principle.

| Dimension | VR1 | VR2 | VR3 |
|---|---|---|---|
| child.surname | [pid, child] | [pid, | |
| | | surname] | |
| child.mother.surname | [pid, child] | [pid, | [pid, |
| | | mother] | surname] |
| child.father.surname | [pid, child] | [pid, | [pid, |
| | | father] | surname] |

| Dimension | CDC1 | CDC2 | CDC3 |
|---|---|---|---|
| child.surname | a=[pid, | b=[pid, | |
| | child] | surname] | |
| child.mother.surname | a | c=[pid, | d=[pid, |
| | | father,mother] | surname] |
| child.father.surname | a | c | e=[pid, |
| | | | surname] |

Now consider an involved example in which is illustrated the use of virtual dimensions and how record-locking is extended into what applicants refer to as the minimum cursor or the minimum degree of freedom principle. Minimum cursor enforcement is intended to provide the semantics that are independent of the actual data layout, thus a part of the mechanisms in the SDL system that abstract data storage. There is a subtle difference between its implementation in automatic locking and explicit record-locking because of the possibility of ambiguity, i.e. multiple reference to the same dimension.

In automatic locking, the minimum cursor principle is implemented by grouping all VDs in a conjunct together that share parts of their join-paths. Within each VD group, all relations at each level are extended, for which the join-paths at lower levels are the same, into a CDC (see definitions in section 2.1.4). This in only done if the merging is unambiguous, i.e. the same dimension is not used more than once in the VD group. If the same VD is repeatedly used in a VD group, the minimum cursor principle can nevertheless be applied without changing the semantics, for the left parts of the join-path that are only based on non-collection relationships, i.e. relationships where the RD joins into a PD that has a PK constraint. In such instances, application of the minimum cursor enforcement is simply a performance issue. For any parts of the join-paths that are to right or at a level where there are collection relationships, independent cursors are used.

In explicit locking, with the record-operator notation, multiple use of the same dimension within a record-expression is always considered the same dimension, thus those join-paths all share the same cursors. Also, like in automatic locking, the relations at each level, which dimensions have join-paths that are equal at lower levels, are extended into a CDC.

First look at automatic locking through a fabricated example that involves multiple types of join-paths:

| { pid \| child.surname = “Smith” AND | |
|---|---|
| child.mother.surname = “Smith” AND | |
| child.father.surname ! = “Smith” } | Ex. 64 |

The minimum cursor principle is based on the assumption that it is most natural and intuitive that a non-ambiguous conjunctive expression, like the one above, be interpreted in such a manner, that dimensions containing child in its name always refers to the same child. This would be the behavior expected from automatic record-locking if the schema was denormalized and all these dimensions where from the same extended pid relation. Table I lists all the join-paths according to the JoinPath algorithm, for the dimension in Ex. (64), and shows the name of the cursors used at each level.

In this example, father and mother are both part of the singleton relation [pid, father, mother] whereas child is a collection that cannot be stored in the same concrete relation. Hence, child is not in the same CDC as father and mother. Notice that according to Table I, three cursors are used for the VR [pid, surname] since it occurs within three different join paths. The SSDL translation of Ex. (64) is now easily written based on Table I:

| SELECT DISTINCT a.<pid> FROM [pid, child] AS a, | |
|---|---|
| [pid, surname] AS b, [pid, father, mother] AS c, | |
| [pid, surname] AS d, [pid, surname] AS e WHERE | |
| a.<child> = b.<pid> AND b.<surname> = “Smith” AND | |
| a.<child> = c.<pid> AND c.<mother> = d.<pid> AND | |
| c.<father> = e.<pid> AND d.<surname> = “Smith” AND | |
| e.<surname> ! = “Smith”; | Ex. 65 |

Because both father and mother are singletons, the merging of [pid, father] and [pid, mother] into a single cursor, c, is simply a performance issue rather than a semantic issue. Clearly, this is not a trivial SSDL statement, however, its structure is relatively straightforward given Table I.

In order to hammer at the semantic meaning of Ex. (64), the reader might recognize that because of the minimum cursor principle, this query should only return the parents who have some “Smith” child whose father is a “non Smith” and whose mother is a “Smith”. Assuming that there are no children born out of wedlock, this should be an empty set. In section 3.3 one saw how the record-operator can be used to minimize the scope of automatic record-locking. Likewise, one can use it to minimize the scope of the minimum-cursor enforcement. Thus, in the case of multiple marriages, the following query might give a non-empty set since independent cursors will be introduced for the children:

| { pid \| child.surname = “Smith” AND | |
|---|---|
| [ child.mother.surname = “Smith” ] AND | |
| [ child.father.surname ! = “Smith” ] } | Ex. 66 |

In Table II there is a similar analysis as in Table I for the query in Ex. (66). The SDL translation follows from the table.

TABLE II
The join-paths for the individual dimensions in Ex. (66) and results
for CDC and shared cursors. Because of the record-operators, the
expression in Ex. (66) is treated as three independent conjuncts.

| Dimension | VR1 | VR2 | VR3 |
|---|---|---|---|
| child.surname | [pid, | [pid, | |
| | child] | surname] | |
| child.mother.surname | [pid, | [pid, | [pid, |
| | child] | mother] | surname] |
| child.father.surname | [pid, | [pid, | [pid, |
| | child] | father] | surname] |
| Dimension | CDC1 | CDC2 | CDC3 |
| child.surname | a=[pid, | d=[pid, | |
| | child] | surname] | |
| child.mother.surname | b=[pid, | e=[pid, | g=[pid, |
| | child] | mother] | surname] |
| child.father.surname | c=[pid, | f=[pid, | h=[pid, |
| | child] | father] | surname] |

The next example illustrates the treatment of ambiguous expression:

{ pid | child.diag = “stro” AND child.diag = “cancer” }

Ex. 67

Here the same dimension is used multiple times in the same conjunct. The interpretation of this query, that is consistent with both normalized and denormalized data layout, is to find individuals that have some child that has been diagnosed with stroke and some child (same or different) that has been diagnosed with cancer. This is an example of where the exception in the minimum cursor implementation kicks in. If this must be one and the same child, then the nested notation must be used because the same dimension is being used multiple times in the same conjunct:

{ pid | child IN { diag = “stro” AND diag = “cancer” } }

Ex. 68

Notice how the above nested SDL notation suggests an alternative approach for translating queries with virtual relations, such as in Ex. (64), i.e. first transform into nested SDL and then use standard SSDL translation:

| { pid \| child IN { surname = “Smith” AND | |
|---|---|
| AND [ mother IN { surname ! = “Smith” } | |
| AND father IN { surname = “Smith” } ] } } | Ex. 69 |

This SDL translation is equivalent to a so-called star-join transformation (Bizarro and Madeira 2001 and Pirahesh et al. 1992) that is used in some RDBMS optimizers to obtain better performance on star-schemas. This is however not guaranteed in all RDBMS and there are examples where this type of rewrite will give worse performance. Ideally, the SQL optimizer should be able to recognize when and how it is optimal to rewrite Ex. (65). In expressions with the ALL keyword or aggregate operators, the rewrite shown in Ex. (69) may not be permissible because of semantic difference for collection relationships. Examples of such are considered later, but first an example where only part of a conjunct is ambiguous:

{ pid | father.diag = “stro” AND father.diag = “cancer”

AND

child.diag = “stro” AND child.diag.date > “2000-01-01” }

Ex. 70

In this case, automatic locking will treat this query as if it was equal to:

{ pid | father.diag = “stro” AND father.diag = “cancer”

AND

[ child.diag = “stro” AND child.diag.date > “2000-01-01” ]

Ex. 71

In other words, child always refers to the same child because the child dimensions are unambiguous whereas father.diag refers to independent diagnosis of the father.

TABLE III
The join-paths for the individual dimensions in
Ex. (72), corresponding CDCs and shared cursors.

| Dimension | VR1 | VR2 |
|---|---|---|
| child.diag | [pid, child] | [pid, diag] |
| child.diag.date | [pid, child] | [pid, diag.date] |
| child.sex | [pid, child] | [pid, sex] |
| child | [pid, childl] | |

| Dimension | CDC1 | CDC2 |
|---|---|---|
| child.diag | a=[pid,child] | b=[pid,diag, diag.date] |
| child.diag.date | a | b |
| child.sex | a | c = [pid, sex] |
| child | a | |

Aggregates can be used in combination with virtual dimensions like concrete dimensions, however, they require a special attention as mentioned above. For instance:

| { pid \| [ COUNT (child.diag) > 1 WHERE child.diag =: | |
|---|---|
| “cancer” AND child.sex = “male” GRBY child ] } | Ex. 72 |

This query finds individuals that have male children with more than two cancer diagnoses. Note the additional GRBY clause. If grouping had been omitted, this query would find individuals for which the total number of cancer diagnosis for all sons is more than one. Particularly noteworthy in this example is that within the record-operator it is possible to use simultaneously virtual dimensions that have join-paths that end in different concrete relation. This is an important property in order to support abstraction of storage. As Table III shows, sex and diag belong to different CDCs. Therefore, one can say that for virtual dimensions of the type pid.child.*, applicants have “extended” the virtual relations as compared to VRs for pid.* which are the CDCs. These extended virtual relations (EVR) will be discussed further in section 6.

With regard to the behavior of the aggregate, in Ex. (72), this extension does not matter because sex is a singleton. However, if sex had been replaced with a collection such as child.drug, the COUNT aggregate operator would yield “unexpected”results due to a multiplication effect from the join. A possible remedy to this problem is to transform p(child.drug) into child IN{p(drug)}. This solution does however not work in general, e.g. cases where predicates depend on multiple dimensions from multiple join-paths. Rather, applicants suggest to raise a warning (through syntax and semantic aware GUI support) or simply to reject virtual relations where the join-path goes through a collection relationship, unless this join-path is part of the join-path of the aggregated dimension itself. Likewise, record-expressions with aggregate operators on multiple join-paths are not accepted if the join-path goes through collection relationship. This is done to avoid “unexpected” behavior from predicates with aggregate operators in EVRs. As an example, the following would be flagged:

{ pid | [ COUNT (child.diag) > 1 WHERE child.drug = “t-PA” ] }

Ex. 73

whereas Ex. (72) is valid and similarly the following:

| { pid \| [ COUNT(child.diag) > 1 WHERE | |
|---|---|
| child IN { drug = “t-PA” } ] } | Ex. 74 |

Before ending this section and the discussion on the minimum cursor principle, it is recognized that so far only expressions that have a single conjunctive term have been presented. More complex expressions can however always be rewritten, by applying the distributive law or an OR-distribution, into CNF (Ramakrishnan and Gehrke 2000). For automatic locking, each conjunct can be considered separately as described above, hence ambiguity would be determined for each conjunct. Within record-expressions, however, OR-distribution is not applied since it can change the result of aggregate predicates.

4.2 Object-Relational Extensions

Virtual dimension are closely related to objects and data encapsulation. SDL is easily extended to use object-relational features such as those provided in Informix UDB (Illustra), DB2, and Oracle9i (Stonebraker 1996). An SDL domain can be defined in terms of extended data types (objects). Similarly, methods that belong to the extended data type can be made accessible visually (in a tree browser) as well as syntactically in the same manner as attributes and virtual dimensions. Furthermore, operators can be overloaded and assigned to domains in the same manner as in languages such as C++ (Stroustrup, B., The C++ Programming language, 2nd ed. Addison-Wesley, 1991). As an example, the “=:” operator in SDL can be overloaded for non-hierarchical data types.

Next are examples with a data type called “segment” that has the methods start( ), stop( ), and chrom( ). Visually, these methods can be shown as leaves under the dimension-node seg, with parenthesis appended, and possibly with information on input parameters. They can be used in an SDL statement as:

{ gene | func =: “GPCR” AND seg.chrom( )=1 AND seg.start( )

| | |
|---|---|
| >10000 } | Ex. 75 |

Similarly, if an object-relational method for evaluating overlap between two segment objects exits, the following query could be used to find if any “non-silent” SNPs (i.e., a single nucleotide polymorphism in DNA that impacts RNA transcription of a gene) overlap GPCR genes:

{ gene | func =: “GPCR” AND $x := seg AND
SIZE({ snp | type =: “nonsilent” AND seg.overlaps ($x) }) > 10 }

Ex. 76

Notice that the binding variable, $x, is of object-relational type. Similarly, it is possible to write $x.method ( ), i.e. to refer to a method through the binding variable. The SIZE keyword in SDL is simply used to evaluate the size of the nested set (see section 5.1).

An important issue with regard to object-relational methods is that they do not require any meta-data management in the SDL system apart from the domain definition. Registration and definition of methods can simply take place at the RDBMS level since the SSDL translator can simply append the methods to the corresponding column names. A related subject is the handling of functions in SDL and so-called template functions that will be discussed in section 5.5.

5. Bidirectional Inlining of SDL and SQL

5.1 Limitations of Plain SDL

The SDL language derives its succinct notation from certain assumptions about its usage. It was merely intended to be a language to make set definition easy and is therefore less generic than other database languages such as SQL or OQL. For instance, calculating properties of sets, such as the average age, is impossible in SDL, and SDL alone cannot be used to define reports or views for sets.

In most cases, the expressions in SDL define objects only based on predicates on their own attributes. To define objects membership in set, based on the properties of other connected objects, requires the existence of a RD and as such, is therefore an extension of the attributes of the object itself.

As an example of a query that is non-trivial with SDL is to find the top 100 oldest males, unless the rank is made into an explicit attribute. This can be done by defining SQL views with the rank attribute and thus the SQL schema and the SDL metadata would be designed to facilitate such a query. The drawback of this approach is that the scope of the query, that defines the basis for the rank, needs to be defined beforehand. The SIZE keyword in SDL does make this type of queries possible. For instance, if one needs to find the top 100 oldest individual that have stroke, this can be achieved with:

{ pid | diag =: “stro” AND $y := yob AND
SIZE({ pid | diag =: “stro” AND yob > $y }) < 99 }

Ex. 77

The SIZE keyword returns the size of the enclosed set. Hence, the above definition returns stroke patients that have fewer than 99 stroke patients older than themselves, i.e. top 100 oldest stroke patients. These types of queries are therefore possible with SDL, although they cannot be considered simple. Neither is the SQL translation and what is worse, it is not an efficient implementation as shown below:

SELECT DISTINCT a.<pid> FROM [pid, diag] AS a, [pid, yob] AS b
WHERE (a.<diag> LIKE “stro*”) AND ( SELECT COUNT(*) FROM (
SELECT DISTINCT c.<pid> FROM [pid, diag] AS c, [pid, yob] AS d
WHERE (c.<diag> LIKE “stro”) AND d.<yob> > b.<yob> ) ) < 99;

Ex. 78

All regular SQL optimizers will evaluate the nested query for every tuple in the outer query and therefore this query can be very expensive computationally and time-wise.

There are other types of queries that are even impossible to do in plain SDL. An example of such a query is to find all individuals which blood pressure is two standard deviations or more from the mean of the blood pressure distribution in people diagnosed with stroke. This is an example where the constraints in an SDL expression are determined by a set-based operator or measure. This type of a query is however possible in languages such as SQL, although they are non-trivial for the novice user.

Finally, there are queries that are outside the scope of the declarative syntax of both SDL and SQL and require either procedural languages or recursive query definitions. A simple example of such set definition is to find a set of individuals that have a specified distribution for an attribute variable such as age. Procedural extension in SQL can however be utilized for such definitions and the integration of SDL and SQL can enable such advanced set-definitions within SDL as well. Such highly specific definitions may however often be more appropriate in special applications than in a generic set-definition language such as SDL.

The limitations of SDL discussed above, such as the lack of being able to calculate properties of sets or to define set-views, make it very desirable to be able to integrate SDL with a language that provides such capabilities. The natural candidate for that is SQL, since both SDL and SQL are relational languages. One can argue that integration with SQL defeats the purpose of SDL and its design principles, i.e. to provide a powerful syntax that is still easy to use for the average user. The importance of SDL and SQL integration resides mainly in the fact that it eases the development of advanced functions in the SDL language itself and it provides software developers and database experts easier way to integrate set-based queries with other functionality such as reporting.

The key to the integration has already been presented in section 2.1.4, i.e. to syntactically map between SDL and SQL metadata as well as to merge virtual relations into the SQL syntax. The integration is bidirectional because SSDL statements can contain SDL definitions and the SDL definitions can contain SSDL statements. This bidirectional inlining therefore leads to what applicants refer to as multiple-recursive compilation of SSDL statements. The recursion continues until pure SQL code comes out. To simplify the development of the SSDL compiler, a pass-through technique is used, i.e. the compiler recognizes proprietary SDL structures and skips over regular SQL keywords and passes them unmodified to the SQL compiler. As long as there is not a conflict between keywords in the SQL grammar and SDL, this makes the SSDL compiler robust for changes in the SQL standard and insensitive to minor flavor differences in SQL.

5.2 SDL Inlined in SQL

The first example shows both a virtual relation and a set-definition bundled into an SQL statement:

SELECT <pid>, <diag> FROM [ pid, diag ] WHERE
<pid> IN { pid | sex = “male” AND diag =: “stroke” };

Ex. 79

This query returns a table with ids of individuals and diagnosis for all male individuals that have ever been diagnosed with stroke. It is however important to point out that the table may very well contain non-stroke diagnoses although all such diagnosis will appear for individuals that also have some stroke diagnoses. This is because the “report” is fully independent from the set-definition itself. In order to limit the report (table) only to stroke diagnosis, the constraint needs to be specified in the WHERE clause of the SSDL statement. The virtual relations are generated with SQL as described earlier and the SQL code that results from the nested SDL query is simply substituted in its place.

A nifty feature is that virtual dimensions are available in SSDL (see also section 6). For instance:

SELECT * FROM [ pid, dob, father, father.dob ];

Ex. 80

This query generates a report on all individuals, showing their date of birth, their father, and their father's date of birth. Thus, although a join is required to generate this table, it happens automatically behind the scenes.
5.3 SQL Inlined in SDL

The most basic approach to include SQL in SDL is through a nested set:

{ pid | pid IN { SELECT <pid> FROM ( SELECT <pid>, <yob>
FROM [ pid, yob] AS r WHERE r.<pid> IN { pid | diag =: “stro” }
ORDER ASC BY r.<yob> DESC) FETCH FIRST 100 ROWS ONLY; } }

Ex. 81

Here, a nested set-definition starts with the SELECT keyword and is therefore treated as SSDL code which is merged with the SQL translation of the rest of the SDL expression. As with nested statements in SQL, it is up to the user to ensure that the SQL code returns a single column output of the proper domain. Notice, however, that the SSDL definition contains inlined SDL as well. This above query is equivalent to Ex. (77), although it is defined in a totally different manner and results in SQL code that performs much better in most circumstances.

A second approach is to use SQL to define a virtual relation. The virtual relation is denoted with the record-operator, within the conjunct where it appears in the SDL expression, e.g.:

{ pid | [ SELECT Cpid AS <pid>, MAX(Cdate) AS <$d>
FROM Tdiagnosis GROUP BY Cpid ] AND [ $d − dob > 99 ] }

Ex. 82

Here Tdiagnosis denotes some table with diagnosis information in the RDBS 102, 103 and Cpid and Cdate appropriate columns in that table. Notice that the virtual relation, which is defined explicitly with SQL, has to contain a column that represents the primary dimension. Also, observe how both of the SQL columns in the SELECT clause are declared in terms of SDL metadata using the angle-brackets. Thus, the binding variable $d is associated with the maximum diagnosis date for each individual and therefore, the overall expression defines a set of all individuals that have been diagnosed after the age of 99. In this case, the SDL compiler recognizes the SQL code in a similar way as in the previous case, i.e. a SELECT keyword following the square-bracket of the record-operator.

The final mechanism to plug SQL into SDL expression is through the SQL number evaluating function, SQLV:

{ pid | AVG(bloodpr.high) > SQLV( SELECT AVG(*) + 2*STD(*)
FROM
(SELECT AVG(<bloodpr.high>) FROM [ pid, bloodpr.high ] WHERE

| | |
|---|---|
| <pid> IN { pid \| diag =: “stro” } ); ) } | Ex. 83 |

This expression finds all individuals which average high level of blood pressure exceeds the average blood pressure of stroke patients. Clearly this is not a simple expression, but then on the other hand, it is a complicated definition that is impossible to do in plain SDL as mentioned in section 5.1. Notice that the function SQLV only returns a single value which is compared with the average blood pressure of every individual.
5.4 Macros and Functions

The SDL system allow macros to be defined that can take as arguments dimensions, sets, and constants. As with standard macro handling in programming languages such as C++, macros are expanded as a part of a pre-processing of the SDL statements and their code is substituted in their place. Such macros can of course also use inlined SSDL in their definitions. Therefore, it would be straightforward to define a TOPNPID macro that simplifies Ex. (81):

{ pid | TOPNPID(100,yob, { diag =: “stro” }) } Ex. 84

The macro definition would resemble the code in Ex. (81). Notice that the name of the macro indicates that it only works in set-definitions where the PD is pid. This is due to limitations of simple macros. Implementation of macros is discussed in the next section since macros are a subset of the more powerful template functions.

However, it is worth mentioning that any scalar SQL functions that are available for table columns are also available in SDL, as long as there is no naming conflict. As an example if the function Foo(integer) is defined in the underlying RDBMS, the following is valid:

| | |
|---|---|
| { pid \| Foo(yob) > 0 } | 85 |

This is a “by-product” from the pass-through implementation of the SSDL compiler and means that new functions can be introduced into SDL simply by creating them at the RDBMS level.
5.5 Template Functions

The fact that SSDL is a language that combines the metadata of SQL and SDL and has all the expressive power of SQL, gives a lot of flexibility in terms of developing advanced functions into the SDL language. Applicants refer to these functions as template functions because, during SDL compilation, they are expanded into SSDL code before the final compilation of the SDL code. There are several things that makes these SDL template functions unique and different from standard macros and standard procedural extensions in SQL. Template functions have the notion of context, i.e. they can be defined in terms of variables that are not really part of the input parameters or the constraints but rather the implicit scope of evaluation. Similarly, they are expanded into SDL/SSDL code, and therefore, they preserve the descriptive nature of SQL. With regard to optimization in the RDBMS 102 this is an especially important property. The best way to describe this is to take an example. Consider the following SDL statement:

{ gene | func =: “GPCR” AND
OVERLAPS ( { snp | type =: “non-silent” } ) } Ex. 86

This query is supposed to find all genes that overlap with non-silent SNPs. The definition of the OVERLAP template function assumes certain naming conventions, i.e. that spatial positions of genes and SNPs are stored in the relations [gene, seg] and [snp, seg], respectively, where seg is an object-relational data type as described in section 4.2. The definition of the template function might look something like:

| OVERLAP(SDLset @1) := [ SELECT g.<PD(@this)> | |
|---|---|
| FROM [PD(@this), seg] AS g, [PD(@1), seg] AS s | |
| WHERE S.<PD(@1)> IN @1 AND | |
| SQLOVERLAPS(g.<seg>, s.<seg>)=1; ] | Ex. 87 |

This template function is based on the virtual-relation approach for inlining, as described earlier. Both @this and @1 refer to sets, the set in which the OVERLAP template is used and the set that is the input to the OVERLAP template function, respectively. The function PD( ) returns the primary dimension of a given set and is easily understood by comparing the definition of OVERLAP with the corresponding code below in Ex. (88). Note that the function SQLOVERLAPS needs to be defined in the RDBMS 102 in order for this template function to work. Once the template function is expanded, it results in the following SDL statement:

| { gene \| func =: “GPCR” AND [ SELECT g.<gene> | |
|---|---|
| FROM [gene, seg] AS g, [snp, seg] AS s | |
| WHERE s.<snp> IN { snp \| type =: “non-silent” } AND | |
| SQLOVERLAPS(g.<seg>, s.<seg>)=1; ] } | Ex. 88 |

Notice that the virtual relation labelled as g refers to gene, although there is no mentioning of gene, neither within the OVERLAP definition nor in the input to the SDL template function. This is what applicants refer to as the unique context property of the template functions. The motivation behind this is the same as for “implicit constraints” in SDL, i.e. gene could have been passed to the template function, however, that would have resulted in longer syntax.

For commutable mathematical operations, like spatial overlap, it is desirable that the RDBMS optimizer can choose the access path, i.e. whether it evaluates SQLOVERLAP(g, s) or SQLOVERLAP(s, g). This is indeed one of the most important optimization issues in access path selections for joins (Selinger, P. G. et al., “Access path selection in relational database management systems,” In Readings in database systems, 3rd ed., M. Stonebraker and J. M. Hellerstein, Eds. Morgan Kaufmann Publishers, Inc., pp. 141-152, 1998). However, most commercial systems that provide extended indexing capabilities for functions (Oracle Corporation, “All Your Data: The Oracle Extensibility Architecture,” Oracle Corporation, Redwood Shores, Calif., Technical White Paper, 1999a and Chaudhuri, S. and K. Shim, “Optimization of queries with user-defined predicates,” ACM Trans. Database Syst. 24(2):177-228, 1999) do not have a built in mechanism to provide hints for the optimizer to recognize such commutability of the operation. A solution, that works in some cases, is simply to expand the operators into the primary operations (=; <;>) that the optimizer knows well how to deal with, e.g. write out overlap as g.<seg>.start( )>s.<seg>.stop( ) . . . in the definition of the template function. This makes it possible to implement commutable functions in SDL that have pure descriptive implementation, hence they do not pre-constrain the access path selection. As an example, if SQLOVERLAP is expanded in Ex. (88), the SQL translation that results is a query for which the optimizer can better decide if the outer relation contains genes and the inner relation SNPs or vice versa. Similar “descriptive” functionality is not possible with current object-relational methods, as in Ex. (76) where the parameter $x that is passed to the method <seg>.overlap( ) can impact the overall access path selection.

6. Extended Virtual Relations

The previous discussion on the record-operator in section 4.1 outlined how the virtual relation could be extended for virtual dimensions from multiple CDCs, e.g. [pid, father.diag, father.sex] where diag and sex are stored in different CDC's. Similarly, the above alluded to the fact that this same extension could be done for concrete dimensions as well, although it does not provide any additional simplifications to queries since the SDL language already has a built in implicit join based on the output primary dimension, as mentioned in section 3.1. Such extension is nevertheless valuable for virtual relations in SSDL and for object (PD) report generation. Here extended virtual relations (EVR) are explained through a few examples but an elaborate definition is not provided since EVR's mimic explicit record-locking and the minimum cursor principle.

Working with dimensions and relations that should be familiar to the reader from earlier examples, the first example is very simple and presents how an EVR is generated with SSDL from two CDCs:

| [ pid, yob, sex, diag, diag.date ] = | |
|---|---|
| SELECT a.<pid>, <yob>, <sex>, <diag>, <diag.date> FROM | |
| [pid, yob, sex] AS a, [pid, diag, diag.date] AS b | |
| WHERE a.<pid> = b.<pid>; | Ex. 89 |

In essence, an EVR abstracts how dimensions from several CDCs are combined together into a single virtual relation, e.g. singleton information such as sex is stored in a different concrete relation than the collection diag. Similarly, one can write [pid, sex, diag, drug], i.e. refer to dimensions from three CDCs. There are however two issues that require special attention when multiple CDCs are combined.

First, when an EVR refers to dimensions from more than one collection CDC, inherently there will be “multiplication effect” on parts of the tuples. This is a consequence of presenting data structures that are more naturally presented as some kind of a hierarchical structure (e.g., XML or the CORBA IIOP format) than as a relational structure. The relational form is however more easily viewed in text editors or spreadsheets and it is directly applicable to further processing using relational languages. As mentioned in section 4.1 this “multiplication effect” from multiple collections does however impact aggregate operators. Singleton clusters are however invariant to equi-join on a PD with another singleton cluster.

Second, equi-join of multiple CDCs could potentially lead to “loss of data” if tuples of a given PD were absent in any of the CDCs. The definition of virtual relations in section 2.1.4 does however guarantee that all the values of a PD in the domain definition set (see section 3.5) has a representative tuple, even though it may only contain NULL values for dimensions other than the PD. Hence, the implementation of EVR in Ex. (89) which uses equi-joins between the CDCs is “non-lossy” by definition. In practice, due to performance reasons, it may not be desirable to implement EVR based on that assumption, but rather build the EVR from concrete relations that only contain non NULL tuples. Applicants define a virtual relation based on a strict fingerprint as:

[[ dₚ, dₐ, d_{b} ]] ≡ [ dₚ, dₐ, d_{b} WHERE dₐ! =NULL OR d_{b}! =NULL ]

Ex. 90

Here a WHERE clause has been introduced in the EVR that has equivalent behavior as in the record-operator in SDL definitions. Now the EVR in Ex. (89) can be defined in terms of CDCs with strict fingerprint:

[ pid, yob, sex, diag, diag.date ] =
SELECT a.<pid>, b.<yob>, b.<sex>, c.<diag>, c.<diag.date>
FROM (SELECT <pid> FROM [pid]) AS a LEFT JOIN
(SELECT <pid>, <yob>, <sex> FROM [[pid, yob, sex]]) AS b
ON a.<pid> = b.<pid> LEFT JOIN
(SELECT <pid>, <diag>, <diag.date> FROM [[pid, diag,

diag.date]])

| | |
|---|---|
| AS c ON a.<pid> = c.<pid>; | Ex. 91 |

This definition is “non-lossy” since it will minimally generate a single row for each pid in the domain definition set (see section 3.5 and the discussion on [pid]).

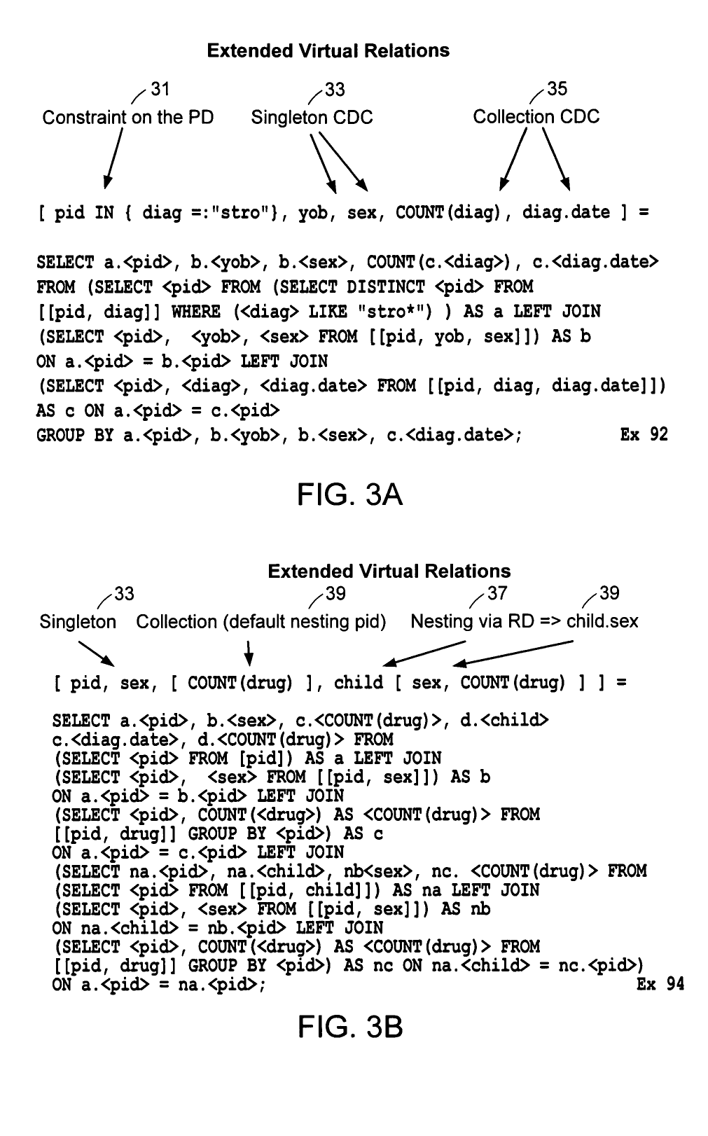

Now consider an example (shown in FIG. 3a) of an EVR with an aggregate operator 35 and a constraint 31 on the PD:

[ pid IN { diag =: “stro” }, yob, sex, COUNT(diag),

diag.date ] =

SELECT a.<pid>, b.<yob>, b.<sex>, COUNT(c.<diag>),

c.<diag.date>

FROM (SELECT <pid> FROM (SELECT DISTINCT <pid> FROM
[[pid, diag]] WHERE (<diag> LIKE “stro*”) ) AS a LEFT JOIN
(SELECT <pid>, <yob>, <sex> FROM [[pid, yob, sex]]) AS b
ON a.<pid> = b.<pid> LEFT JOIN
(SELECT <pid>, <diag>, <diag.date> FROM [[pid, diag,

diag.date]])

AS c ON a.<pid> = c.<pid>
GROUP BY a.<pid>, b.<yob>, b.<sex>, c.<diag.date>; Ex. 92

Predicates can be applied directly where the output dimensions in the EVR are listed or in a WHERE clause as shown earlier. The domain definition relation [pid] in Ex. (91) has been replaced with the SSDL translation of the constraining set for pid. Observe that the grouping is implicitly determined by the non-aggregated output-dimensions. Most importantly, the grouping is by pid and diag.date. Because both yob and sex are singletons 33, they yield no further segregation than pid. If drug had been included as well, i.e. a dimension from another collection than diag, the aggregation would have been “incorrect”. Proper aggregation can nevertheless be achieved with the aid of nested EVR notation:

[ pid, yob, sex, [ COUNT(diag), diag.date ], [ COUNT(drug) ]
WHERE pid IN { diag =: “stro” } ] =
(SELECT a.<pid>, b.<yob>, b.<sex>, c.<COUNT(diag)>,
c.<diag.date>, d.<COUNT(drug)> FROM
(SELECT <pid> FROM (SELECT DISTINCT <pid> FROM
[[pid, diag]] WHERE (<diag> LIKE “stro*”) )
AS a LEFT JOIN
(SELECT <pid>, <yob>, <sex> FROM [[pid, yob,
sex]]) AS b
ON a.<pid> = b.<pid> LEFT JOIN
(SELECT <pid>, COUNT(<diag>) AS <COUNT(diag)>,
<diag.date> FROM
[[pid, diag, diag.date]] GROUP BY <pid>,
<diag.date>) AS c
ON a.<pid> = c.<pid> LEFT JOIN
(SELECT <pid>, COUNT(<drug>) AS <COUNT(drug)> FROM [[pid,
drug]]
GROUP BY <pid>) AS d

| | |
|---|---|
| ON a.<pid> = d.<pid>; | Ex. 93 |

Notice how the scope of the aggregation and the grouping is within the square brackets. Therefore, this “report” returns demographic information on individuals, their number of diagnosis, as a function of date, as well as their number of drug prescriptions. Similarly, as shown in FIG. 3b, it is possible to use RD 37 and nested EVR notation 39 to create nested reports:

[ pid, sex, [ COUNT(drug) ], child [ sex, COUNT(drug) ] ] =
SELECT a.<pid>, b.<sex>, c.<COUNT(drug)>, d.<child>
c.<diag.date>, d.<COUNT(drug)> FROM
(SELECT <pid> FROM [pid]) AS a LEFT JOIN
(SELECT <pid>, <sex> FROM [[pid, sex]]) AS b
ON a.<pid> = b.<pid> LEFT JOIN
(SELECT <pid>, COUNT(<drug>) AS <COUNT(drug)> FROM
[[pid, drug]] GROUP BY <pid>) AS c
ON a.<pid> = c.<pid> LEFT JOIN
(SELECT na.<pid>, na.<child>, nb.<sex>, nc.<COUNT(drug)> FROM
(SELECT <pid> FROM [[pid, child]]) AS na LEFT JOIN
(SELECT <pid>, <sex> FROM [[pid, sex]]) AS nb
ON na.<child> = nb.<pid> LEFT JOIN
(SELECT <pid>, COUNT (<drug>) AS <COUNT(drug)> FROM
[[pid, drug]] GROUP BY <pid>) AS nc ON na.<child> = nc.<pid>)

| | |
|---|---|
| ON a.<pid> = na.<pid>; | Ex. 94 |

The above report shows gender and the number of drug prescriptions for individuals as well as the same information for each of the individuals children. Aggregation is both per child and per individual. The following EVR is also permissible and is created using the minimum cursor principle:

[pid, sex, COUNT(drug), child, child.sex, COUNT(child.drug)]

Ex. 95

It does however not give the same results as the preceding EVR due to the multiplication effect. Another aspect to pay attention to is that the nested EVR [sex, COUNT (drug)] 39 has an implicit PD that is derived from the domain of child. This is a similar concept as the implicit output dimension for nested sets in SDL expression as presented in Ex. (48) in section 3.6. Clearly, the EVR notation is much more concise than the corresponding SSDL translation, not to mention the SQL translation which can be even longer because of the expansion of the concrete virtual relations.
6.1 Pivoting

Extended virtual relations can be regarded as an automatic mechanism to represent data as a horizontal structure (Agrawal et al. 2001). Therefore they are also closely related to pivoting and unpivoting of data, for which SQL extensions have recently been introduced (Graefe, G. and J. Alger, “Electronic database operations for perspective transformations on relational tables using pivot and unpivot columns,” U.S. Pat. No. 6,298,342 and Johnson, T. and D. Chatziantoniou, “Extending complex ad-hoc OLAP,” In Proceedings of the 1999 ACM CIKM International Conference on Information and Knowledge Management, Kansas City, Mo., Nov. 2-6, 1999, ACM, 170-179), but are indeed a part of a more general paradigm for representing tables (Gyssens, M. et al., “Tables as a paradigm for querying and restructuring,” In Proceedings of the Fifteenth ACM SIGA CT-SIGMOD-SIGART Symposium on Principles of Database Systems, Jun. 3-5, 1996, Montreal, Canada, ACM Press, 93-103). Presentation of data in a pivoted form is often desired such as in data mining of association rules or “market basket” analysis (Agrawal, R. and R. Srikant, “Fast algorithms for mining association rules in large databases,” in VLDB '94, Proceedings of 20th International Conference on Very Large Data Bases, Sep. 12-15, 1994, Santiago de Chile, J. B. Bocca et al. Eds. Morgan Kaufmann, 487-499).

Next is introduced how the virtual relations can be used to provide such functionality. Instead of introducing new SDL/SSDL keywords, the present invention utilizes new system dimensions in a similar fashion as in Ex. (11). This addition is confined to the construction of VRs and does not impact the semantics of the language or its compilation in any way. Consider the following virtual relation:

| | |
|---|---|
| [ sys.dim, value, objid ] | Ex. 96 |

By definition, this VR should pivot all accessible data in the database into a vertical representation (Agrawal et al. 2001). The PD sys.dim is the “column” with the name of the dimension, value is the dimension value (of data type ANY or STRING), objid is a unique id for a tuple. Thus, using SSDL, it should be possible to construct any other relation from the one in Ex. (96). How the relation in Ex. (96) is generated will depend on the underlying data structures—with the present invention multi-table schema, it could become a hefty union statement whereas with a vertical layout it would simply be a plain select from a single table. Typically, one is however not interested in the “whole database” and the logic behind the VR should be able to exclude tables that will not provide the right data, similar to the approach presented in section 2.2.1. For instance, the following is possible:

[ sys.dim, value.int WHERE
sys.dim IN { projid = 1 AND datatype = “integer” } ]

Ex. 97

The idea is that any attributes that are available on the dimensions can be used to qualify which dimensions to include in the pivoting, i.e. use a bootstrapping approach where one specifies SDL dimensions using SDL expressions. Similar ideas where the schema or the metadata can be queried to form a data query have been presented in other languages such as SchemaSQL (Lakshmanan, L. V. S. et al., “On efficiently implementing SchemaSQL on a SQL database system,” in Proceedings of the 25th VLDB Conference, Edinburgh, Scotland 1999) and XSQL (Kifer, M. et al. 1992).

To provide a more intuitive and concise notation, it is also possible to let the presence of the dimension value.int imply that datatype=“integer”. Furthermore, if a system relation is defined where the PD sys.dim is associated with all other dimensions, it possible to imply only pivoting of the concrete relations for which they appear in:

[ sys.dim, value.string, pid WHERE sys.dim IN { singleton } ]

Ex. 98

The above means pivoting of all dimensions that occur within a relation with the dimension pid that are of type string and are singletons. Note, here the sys.dim is the PD whereas sys.dim.pid is not. The implied constraint is equivalent to sys.dim IN {rel.dim=“pid”}, i.e. the dimension has to be in relation with pid. In the same manner, it is possible to introduce a system dimension and corresponding VR that are available for all PD, e.g. [pid, pid.dim.name, pid.dim.value] to access all dimensions associated with pid.

Similarly, dimensions that are collections can be included as well, however, they require the dimension objid to be meaningful (non ambiguous) in the output. Consider now the following SDL query:

{ pid | sex = “male” AND pid IN { SELECT a.<pid> FROM
[ sys.dim, value, pid WHERE sys.dim IN { singleton } ] AS a
WHERE a.<value> != NULL; } } Ex. 99

The above query finds all males for which all the singleton dimensions in the schema are defined. Although this query has no particular meaning, it demonstrates the power of the data abstraction with virtual relations and the possibility to merge SSDL (SQL) into SDL expressions. Other variants of VRs are also possible and system dimension or dimension attributes that “exist” in multiple relations are for instance useful to constrain the scope of queries, e.g. projects, users etc.
7. Discussion

In this work applicants have provided SDL, a language for defining sets of objects based on relational data structures. One of the primary goals of the SDL project was to enable non-expert users to issue ad-hoc queries, in particular queries on clinical and genetic data. To achieve this, applicants through the present invention define a language syntax that enables very simple queries to be generated using GUI support such as drag-and drop and relieved the user from logical navigation of relations. While the aim was to make simple queries as easy as possible, applicants have also tried to ensure enough expressiveness such that the invention language covers a sufficiently wide range of query classes. A pragmatic approach was taken and attempts to ensure that the language could be implemented effectively on commercial RDBMS were made. As a consequence of this approach, the SDL language can be integrated relatively easily with SQL. This allows any lack of expressive power in the SDL language to be compensated with SQL, either through explicit bidirectional inlining or by augmenting SDL with template functions.

The present invention SDL language provides a simple, yet powerful construct to deal with high-dimensional life-science data as well as event based clinical data. In particular, temporal expressiveness is provided in SDL through the use of binding variables. Therefore, one can say that time is handled explicitly in SDL since the language does not have specific language constructs that deal with time implicitly. Such implicit handling of time may however be of interest (Nigrin and Kohane 2000) and future research on SDL may involve analysis of the possibility of combining SDL with languages, such as TSQL, designed specifically for temporal databases (Snodgrass, R., “The temporal query language TQuel,” ACM Trans. Database Syst. 12(2):247-298, 1987; Snodgrass, R. T., Developing Time-Oriented Database Applications in SQL Morgan Kaufman Publishers, Inc., 1999; and Connor et al. 1999). As an example, one can envision extending the implicit join in SDL to include an additional temporal dimension with an implicit overlap predicate. At the moment, such integration is hampered by the unavailability of commercial temporal database systems. It is also possible to envision future additions that are more easily reached. They may include the creation of additional record keywords, e.g. FIRST and LAST, or even additions based on some of the new language constructs in SQL3 (ISO-ANSI. 1997. ISO-ANSI working draft, (SQL/foundation). Tech. Rep. DBL:LGW-008, ISO/IEC JTC1/SC21/WG3 Database, American National Standards Institute. April 1997) such as order based aggregate operators for relations. Today, these features have to be used through SSDL inlining or template functions.

Although one embodiment is based on a dynamic multi-table RDBMS schema, relational data abstraction is an essential part of the language design. SDL has a cursor free notation, i.e. there is no reference to relation names and cursors do not have to be declared explicitly. With this design approach, expressions with predicates on multiple attributes per tuple (relation) are enforced with automatic record-locking or the minimum cursor principle, if there is no ambiguity, and with explicit record-locking where there are multiple references to the same attribute.

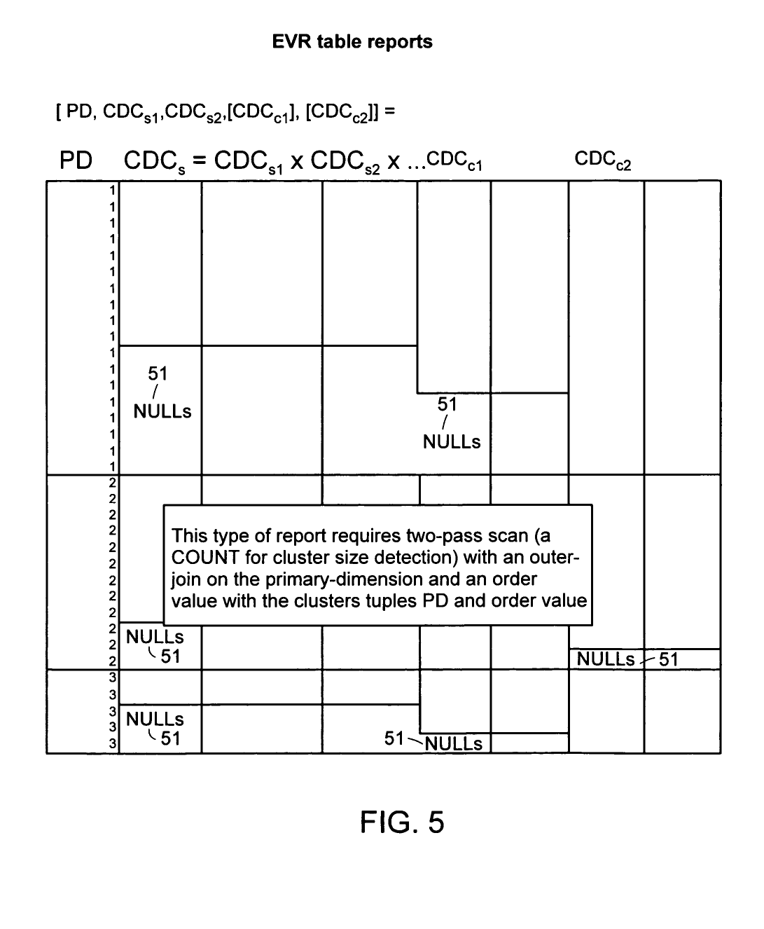

Virtual relations and the CDC concept were also introduced for data abstraction and to enable schema evolution. In an ideal world, where it is possible to design a schema that can capture all expected data, a single RDBMS table could represent each CDC, i.e. each CDC would have a horizontal data structure. See FIG. 5. Attributes that are missing can be substituted with NULLs 51. In practice, where the schema evolves and new attributes may be generated, this requires that the RDBMS 102 allows populated tables to be modified (e.g., new columns are NULL 51 padded for existing tuples), something which is not possible in all commercial systems. Similarly, if a vertical storage model is used, the present invention definition of VR allows data from multiple data imports into several overlapping concrete relations to be automatically NULL padded. Therefore, the definition of a CDC in SDL allows virtual relations to be generated dynamically based on dimension fingerprints and the registered concrete relations and hides whether those concrete relations are stored in a vertical, horizontal or even federated manner (Haas, L. M. et al, “Data integration through database federation,” IBM Systems Journal 41(4) 578-596, 2002 and Haas, L. M. et al., “DiscoveryLink: A system for integrated access to life sciences data sources,” IBM Systems Journal 40(2):489-511, 2001).

In the example illustrated in FIG. 5, a report generated from the subject table requires a two-pass scan. In one pass a COUNT for cluster size detection is made. An outer join is made on the primary dimension and an order value with the cluster tuples PD and order value.

It should nevertheless be acknowledged that equivalent abstraction could be achieved by assigning a single RDBMS 102 view to each CDC and then alter the definition of the view as the schema evolves. Indeed, one can argue that views, table functions, extendable virtual table interfaces as well as indices are all some form of data abstraction that exists in current database systems. Thus, it is more of a question whether the abstraction is implemented in the “table interface” or the interface between the languages, SDL and SQL, as in one embodiment of the present invention. The present invention approach is less dependent on the flavor of the underlying RDBMS and is easier and more flexible with regard to implementing dynamic session dependent federation, i.e. where each session may have different concrete relations registered, and where session dependent scoping parameters impact how virtual relations are constructed.

Virtual relations and the emphasis on data abstraction in the SDL system resembles in many ways earlier work on the universal relation model (Maier et al. 1984). Although there are similarities, there are also some important differences. In SDL, the present invention introduces the concept of a primary dimension which makes the role of the related dimensions unambiguous and also the concept of implicit joins. Additionally, in SDL the present invention allows path-expressions with virtual relations that define join-paths unambiguously. Collections and multiple reference to collection dimensions is handled in SDL, however, it is not clear how this can be resolved in the universal relational model without the use of explicit joins and aliases—the same thing applies to EVRs in SSDL.

There are some similarities between the construction of virtual relations in SDL and the binding phase in the weak universal relation model. Ideas based on the use of implicational dependencies, as described by Maier et. al. (1984), could possibly be used in the definition of virtual relations. Applicants recognize that with mixed fragmentation of relations (Meghini, C. and C. Thanos, “The complexity of operations on a fragmented relation,” ACM Trans. Database Syst. 16(1):56-87, 1991), the current invention definition of virtual relation based on a CDC is inadequate given the specification of the minimum cursor principle. For instance, if there are registered concrete relations for [pid,yob], [pid, yod], and [pid, yob, yod], the SDL system could fail to identify individual for which data on the same individual is stored in two binary relations. This would happen if the query has an expression with predicates on both yob and yod within the same conjunct. For singleton relations, it is relatively easy to provide a remedy to this problem, either by relaxing the minimum cursor principle or by modifying the construction of the virtual relations. This type of work-around may still have some performance implications and is not easily extended to collections. For the time being, the present invention does not fully support mixed fragmentation.

Data updates in the universal relational model are non-trivial and require the definition of insert-able tuples (Brosda, V. and G. Vossen, “Update and retrieval in a relational database through a universal schema interface,” ACM Trans. Database Syst. 13(4):449-485, 1988). Currently, the invention SDL system only supports import into concrete relations that contain the dimension fingerprint of the imported data and therefore complications of this nature do not come up in SDL. Similar issues could however arise if the present invention allows import of data into EVR. Some functionality of this kind might however be very useful such as for populating star-schemas. Actually, applicants believe that a functionality that is currently available and of equal or higher importance is the ability to link or register concrete relations with data that has already been imported to the underlying RDBMS 102, 103. In the invention multi-table layout, dimensions are simply assigned to columns in tables or views. This makes an external application, or a data administrator, responsible for managing the data and gives full control and direct access to all the indexing features in the RDBMS. In this case, the SDL system provides just read-only access for data analysis.

Related to the previous subject is the fact that the SDL metadata 17 does not enforce integrity constraints although domain definitions are used to validate data that is imported through the SDL import manager. Instead, the SDL system relies on standard RDBMS features for that purpose. The assignment of a domain to dimensions does nevertheless provide implicit logical connections between columns as compared to more explicit connection using foreign-key constraints in the RDBMS. In principle, foreign-key constraints could be used to provide comparable logical navigation between relations. That approach would not have provided the same flexibility for federation, because such constraints cannot span multiple database instances, and in particular, session dependent federation would be impossible. Also, regular RDBMS foreign-key constraints would not work with vertical data layout.

The metadata in SDL is rather to provide schema abstraction for queries as well as to make the interpretation of data application independent via metadata sharing. In this regard, SDL metadata is quite comparable to XML schemas (Chamberlin 2002), and applicants are convinced that it is possible to devise some mappings between the two since both forms can represent relational data structures (Funderburk et al. 2002). A key difference between the two is that the same RDBMS 102 relations can be mapped multiple times with different dimensions in SDL, e.g. relations that store information on multiple objects. Due to its hierarchical form, the XML format has however an inherent one-to-many structure and representation of data that has many-to-many or many-to-one connections, such as in DAGs, is not easily supported except with the use of references. Hence, applicants believe that the SDL metadata framework is better suited for data that requires incremental updates and where multiple “views” on the same data tuples is valuable. Such data views are generated in the SDL system by defining primary dimensions and their related dimensions.

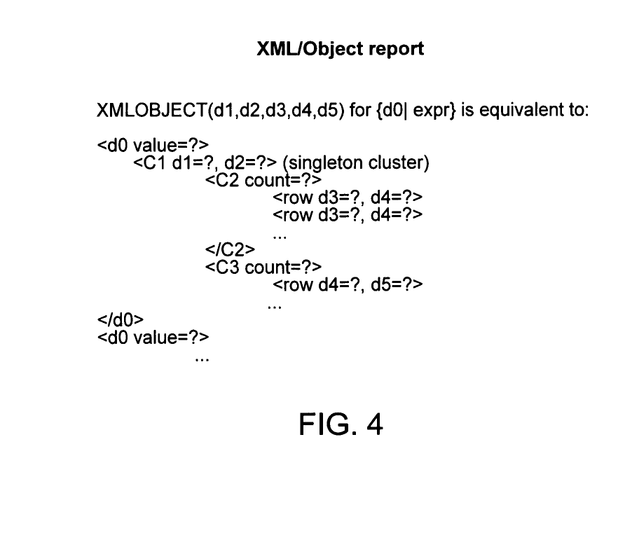

For transaction-based data transfer of relatively few objects, XML structure may be utilized as illustrated in FIG. 4. The same applies to reports, especially when objects contain multiple collection attributes. In the example illustrated in FIG. 4, there is one <d0> node for each item in the set {d0|expr}. Cluster names may be based on a common prefix of the dimensions in the corresponding cluster. Therefore automatic translation of reports into XML form, based on EVR notation as described in section 6, should be valuable. Furthermore, the possibility of combining SDL metadata with XML schemas as well as the languages SDL and XQuery should be of general interest.

A. THE SDL SYNTAX

| | |
|---|---|
| sdl-set: | { dimension \| expression } |
| | { constantlist } |
| constantlist: | constant |
| | constantlist, constant |
| expression: | code-expression |
| | expression AND expression |
| | expression OR expression |
| | NOT expression |
| | ( expression ) |
| | [ record-expression ] |
| | [ aggregate-record-expression ] |
| | [ aggregate-record-expression |
| | GRBY dimensionlist ] |
| | ALL[ record-expression ] |
| | ALL[ aggregate-record-expression ] |
| | ALL[ aggregate-record-expression |
| | GRBY dimensionlist ] |
| parameterlist: | parameter |
| | parameterlist, parameter |
| dimensionlist: | dimension |
| | dimensionlist, dimension |
| parameter: | calc-expr |
| record-expression: | code-expression |
| | record-expression AND |
| | record-expression |
| | record-expression OR |
| | record-expression |
| | NOT record-expression |
| | ( record-expression ) |
| aggregate-record-expression: | record-expression |
| | record-expression WHERE |
| | record-expression |
| code-expression: | dimension =: code-value |
| | relational-expression |
| | setname(parameterlist) |
| | dimension IN sdl-set |
| | binding-variable := calc-expr |
| relational-expression: | calc-expr rel-op calc-expr |
| rel-op: | >, <, >=, <=, =, !=, =: |
| calc-expr: | constant (e.g. domain code-value) |
| | binding-variable |
| | parameter |
| | dimension |
| | ( calc-expr ) |
| | calc-expr |
| | calc-expr calc-op calc-expr |
| | SQLFUNCTION( calc-expr ) |
| | SQLFUNCTION( dimensionlist ) |
| | aggregate-op(dimension) |
| | SIZE( sdl-set ) |
| calc-op: | +, −, *, / |
| aggregate-op: | COUNT, DISTINCT, AVG, STD, |
| | VAR, MAX, MIN |

This language syntax is intended to be an aid to comprehension. It is for purposes of illustrating and not limiting the invention SDL language or its implementation.

While this invention has been particularly shown and described with references to preferred embodiments thereof, it will be understood by those skilled in the art that various changes in form and details may be made therein without departing from the scope of the invention encompassed by the appended claims.

1. In a computer system, a method of defining sets of data to be retrieved from a data store, comprising the steps of:
providing a written representation of a desired data set in terms of dimensions and relation instances, the desired data set having a certain set type;
implying constraints on relation instances or dimensions based on the set type of the desired data set and dimension expressions, and
using the written representation to query the data store and retrieve the desired data set, including enforcing expressions that have predicates on multiple attributes per conjunct in a non-ambiguous way using automatic record-locking such that the predicates on attributes from a same relation are automatically enforced on a same record.

2. A method as claimed in claim 1 further comprising the step of:
enforcing non-ambiguous expressions with multiple concrete dimensions or virtual dimensions or both, using automatic record-locking based on a minimum cursor principle.

3. A method as claimed in claim 1 wherein the written representation makes multiple references to a same attribute; and
the step of enforcing utilizes explicit record-locking based on a minimum cursor principle.

4. A method as claimed in claim 1 wherein the step of providing a written representation includes using an expression with extended virtual relations, said extended virtual relations including one of (i) predicates on dimensions and (ii) a WHERE clause within a record operator.

5. A method as claimed in claim 4 wherein the expression further uses nested record-operators.

6. A method as claimed in claim 1 wherein the step of providing a written representation includes using an expression with extended virtual relations having dimensions from more than one relation, and further comprising the step of transparently assembling the virtual relations with equi-joins or outer-joins of primary dimensions, based on the predicates in the extended virtual relation.

7. A method as claimed in claim 6 wherein the extended virtual relation can contain virtual dimensions; and
further comprising the step of transparently generating and assembling the virtual relations based on a minimum cursor principle and path expressions of the corresponding virtual dimensions.

8. A method as claimed in claim 7 wherein extended virtual relations are used as relations in SQL.

9. A method as claimed in claim 7 wherein the extended virtual relation may include aggregate operators; and
further comprising the step of automatically applying SQL GROUP BY conditions and predicates within each relation based on the dimensions listed in the output of the given extended virtual relation or the dimension within a nested record operator.

10. In a computer system, apparatus for defining sets of data to be retrieved from a data store, comprising:
an input component for providing a written representation of a desired data set in terms of dimensions and relation instances, the desired data set having a certain set type; and
an assembly coupled to receive the written representation, in response the assembly implying constraints on relation instances or dimensions by one of the set type of the desired data set and dimension expressions, and
wherein the written representation has an expression with predicates on multiple attributes per relation, the assembly enforces the expression using automatic record-locking such that the predicates on attributes from a same relation are automatically enforced on a same record.

11. Apparatus as claimed in claim 10 wherein the assembly enforces non-ambiguous expressions with multiple concrete dimensions or virtual dimensions or both, using automatic record-locking based on a minimum cursor principle.

12. Apparatus as claimed in claim 10 wherein the expression has multiple references to a same attribute, the assembly enforces the expression using explicit record-locking based on a minimum cursor principle.

13. Apparatus as claimed in claim 10 wherein the written representation has an expression with an extended virtual relation, the extended virtual relation including one of (i) predicates on dimensions and (ii) a WHERE clause within a record operator.

14. Apparatus as claimed in claim 13 wherein the expression further uses nested record-operators.

15. Apparatus as claimed in claim 10 wherein the written representation has an expression with an extended virtual relation having dimensions from more than one relation; and
the assembly performs an equi-join between the relations that only have non-null dimensions.

16. Apparatus as claimed in claim 15 wherein the extended virtual relation can contain virtual dimensions; and
the assembly generates and assembles the virtual relations based on a minimum cursor principle and path expressions of the corresponding virtual dimensions.

17. Apparatus as claimed in claim 16 wherein extended virtual relations are used as relations in SQL.

18. Apparatus as claimed in claim 16 wherein the extended virtual relation may include aggregate operators; and
the assembly applies SQL GROUP BY conditions and predicates within each relation based on the dimensions listed in the output of the given extended virtual relation or the dimension within a nested record operator.
